(19) United States
(12) Patent Application Publication
(10) Pub. No.: US 2026/0043670 A1
(43) Pub. Date: Feb. 12, 2026

(54) INFORMATION PROCESSING DEVICE, USER TERMINAL, AND INFORMATION PROCESSING METHOD

(71) Applicant: MICWARE CO., LTD., Hyogo (JP)

(72) Inventors: Kenji NARUSHIMA, Hyogo (JP); Maya Lee, Hyogo (JP)

(73) Assignee: MICWARE CO., LTD., Hyogo (JP)

(21) Appl. No.: 19/362,458

(22) Filed: Oct. 19, 2025

Related U.S. Application Data
(63) Continuation of application No. PCT/JP2023/016412, filed on Apr. 26, 2023.

(51) Int. Cl. G01C 21/00; G06F 3/0482; G06Q 30/0207

(52) U.S. Cl. CPC G01C 21/3815; G06F 3/0482; G06Q 30/0239

(57) ABSTRACT

An information processing device 1 includes: a list acquisition portion 134 that acquires list information including selection objects corresponding to each of a plurality of mobile terminals that match a selection condition, the selection objects being for selecting moving images transmitted by mobile terminals; a list output portion 142 that outputs the list information; a selection acceptance portion 123 that accepts an instruction for one selection object with respect to a list using the list information; a moving image acquisition portion 135 that acquires a moving image associated with the one selection object for the instruction accepted by the selection acceptance portion 123; and a moving image output portion 143 that outputs the moving image, thereby moving images desired by users may be provided from moving images transmitted by a plurality of mobile terminals.

### CROSS-REFERENCE TO RELATED APPLICATION

This application is a continuation of PCT International Application No. PCT/JP2023/016412, filed on Apr. 26, 2023. The entirety of the above-mentioned patent application is hereby incorporated by reference herein and made a part of this specification.

### BACKGROUND

### Technical Field

The disclosure relates to an information processing device and the like that accepts a user's selection for a list of moving images and outputs a moving image corresponding to the selection.

### Description of Related Art

Conventionally, there has been a content providing method that displays on the user terminal an image corresponding to the position of the user terminal as the user terminal moves from a departure point to a destination (see Patent Document 1 (Japanese Patent Application Laid-Open (JP-A) No. 2020-42025)).

However, in the conventional technology, it was not possible to provide a moving image desired by a user from moving images transmitted by multiple mobile terminals.

### SUMMARY

The information processing device of the first invention includes a list acquisition portion that acquires list information including selection objects corresponding to each of a plurality of mobile terminals that match a selection condition, the selection objects being for selecting moving images transmitted by mobile terminals; a list output portion that outputs the list information; a selection acceptance portion that accepts an instruction for one selection object with respect to a list using the list information; a moving image acquisition portion that acquires a moving image associated with the one selection object for the instruction accepted by the selection acceptance portion; and a moving image output portion that outputs the moving image.

With such a configuration, it is possible to provide a moving image desired by a user from moving images transmitted by multiple mobile terminals.

Further, the information processing device of the second aspect is, with respect to the first aspect, an information processing device in which the list acquisition portion acquires list information including a plurality of selection objects including one or more road attribute values related to roads on which a mobile terminal moves.

With such a configuration, a user may easily select a desired moving image from moving images transmitted by multiple mobile terminals.

Further, the information processing device of the third aspect is, with respect to the second aspect, an information processing device in which the one or more road attribute values include attribute values of roads through which the mobile terminal has passed or attribute values of a current position of the mobile terminal.

With such a configuration, it is possible to output list information that makes it easy to select a moving image.

Further, the information processing device of the fourth aspect is, with respect to any one of the first to third aspects, an information processing device that further includes a map acquisition portion that acquires map information clearly indicating positions of each of the plurality of mobile terminals; and a map output portion that outputs the map information when the list information is being output.

With such a configuration, as a result of being able to output list information and map information for moving image selection, it becomes easy for a user to select a moving image.

Further, the information processing device of the fifth aspect is, with respect to any one of the first to fourth aspects, an information processing device that further includes a determination portion that refers to a terminal management portion in which terminal information including one or more attribute values is stored in association with each of a plurality of mobile terminals, and determines a plurality of mobile terminals corresponding to one or more attribute values that match the selection condition, in which the list acquisition portion acquires list information including selection objects corresponding to each of the plurality of mobile terminals determined by the determination portion.

With such a configuration, since appropriate multiple mobile terminals are selected, it is possible to output appropriate list information for moving image selection.

Further, the information processing device of the sixth aspect is, with respect to any one of the first to fifth aspects, an information processing device that further includes an inquiry acceptance portion that accepts a query having destination information, in which the selection condition is that location information included in destination information or route information corresponding to the mobile terminal satisfies a related condition with respect to the destination information accepted by the inquiry acceptance portion.

With such a configuration, since appropriate multiple mobile terminals are selected, it is possible to output appropriate list information for moving image selection.

Further, the information processing device of the seventh aspect is, with respect to any one of the first to sixth aspects, an information processing device in which the moving image acquisition portion acquires a moving image shot previously that is associated with the one selection object.

With such a configuration, moving images shot previously may also be output.

Further, the information processing device of the eighth aspect is, with respect to any one of the first to seventh aspects, an information processing device in which the moving image acquired by the moving image acquisition portion is associated with a beneficiary identifier that identifies a beneficiary of the moving image, and the information processing device further includes a beneficiary processing portion that performs beneficiary processing, which is a processing related to a beneficiary identified by a beneficiary identifier associated with the moving image.

With such a configuration, appropriate processing related to the beneficiary of the moving image may be performed.

Further, the information processing device of the ninth aspect is, with respect to the eighth aspect, an information processing device in which the beneficiary processing portion includes a reward means that performs a reward processing, which is a processing for giving rewards to each beneficiary identified by the beneficiary identifier.

With such a configuration, it is possible to give a reward to the beneficiary of the moving image shot by the mobile terminal.

Further, the information processing device of the tenth aspect is, with respect to the ninth aspect, an information processing device in which the reward means also performs a reward processing for a beneficiary with respect to one or more of the selection objects that are mobile terminals corresponding to the selection objects and is associated with moving images other than the moving image acquired by the moving image acquisition portion.

With such a configuration, it is possible to give a reward also to those who contributed to the configuration of the list information.

Further, the information processing device of the eleventh aspect is, with respect to any one of the eighth to tenth aspects, an information processing device in which the beneficiary processing portion includes a third conservation means that accumulates a moving image output by the moving image output portion in association with a beneficiary identifier that identifies a user who requested the moving image.

With such a configuration, the beneficiary of the moving image may be made the beneficiary who needs the moving image.

Further, the user terminal of the twelfth aspect includes a user processing portion that determines whether or not a query condition for acquiring list information has been met; a user transmission portion that transmits a query to an information processing device when the user processing portion determines that the query condition has been met; a user reception portion that receives list information from the information processing device in response to transmission of the query; a user output portion that outputs a list based on the list information, the list being for selecting moving images; and a user acceptance portion that accepts a selection instruction for one selection object among selection objects included in the list, in which the user transmission portion transmits a selection instruction corresponding to the one selection object to the information processing device, and the user reception portion receives a moving image from the information processing device in response to transmission of the selection instruction, the user output portion outputs the moving image.

With such a configuration, it is possible to provide a moving image desired by a user from moving images transmitted by multiple mobile terminals.

### BRIEF DESCRIPTION OF THE DRAWINGS

FIG. 1 is a conceptual diagram of an information system A in Embodiment 1.

FIG. 2 is a block diagram of the same information system A.

FIG. 3 is a block diagram of the same information processing device 1.

FIG. 4 is a flowchart describing an operation example of the same information processing device 1.

FIG. 5 is a flowchart describing an example of the same list configuration processing.

FIG. 6 is a flowchart describing an example of the same moving image acquisition processing.

FIG. 7 is a flowchart describing an example of the same fourth conservation processing.

FIG. 8 is a flowchart describing an example of the same reward processing.

FIG. 9 is a flowchart describing an operation example of the same mobile terminal 2.

FIG. 10 is a flowchart describing an operation example of the same user terminal 3.

FIG. 11 is a diagram showing the same terminal management table.

FIG. 12 is a diagram showing the same inquiry management table.

FIG. 13 is a diagram showing the same output example.

FIG. 14 is a diagram showing the same output example.

FIG. 15 is a diagram showing the same output example.

FIG. 16 is a diagram showing the same output example.

FIG. 17 is a diagram showing the same output example.

FIG. 18 is a diagram showing the same output example.

FIG. 19 is a diagram showing the same output example.

FIG. 20 is a diagram showing the same output example.

FIG. 21 is an overview diagram of the same computer system.

FIG. 22 is a block diagram of the same computer system.

### DESCRIPTION OF THE EMBODIMENTS

According to the information processing device of the disclosure, it is possible to provide a moving image desired by a user from moving images transmitted by multiple mobile terminals.

Hereinafter, embodiments of an information processing device and the like will be described with reference to the drawings. It is noted that components assigned the same reference numerals in the embodiments perform similar operations, so repeated descriptions may be omitted.

### Embodiment 1

In this embodiment, an information processing device that outputs list information having selection objects for selecting moving images transmitted by multiple mobile terminals will be described. It is noted that in consideration of the ease of selection of selection objects by the user, it is preferable that the selection objects include one or more road attribute values related to roads on which the mobile terminals move. The road attribute value is, for example, the congestion level of the road.

Further, in this embodiment, an information processing device that selects multiple mobile terminals based on selection conditions will be described.

Further, in this embodiment, an information processing device that outputs moving

images for selected selection objects will be described. Further, in this embodiment, previous moving images for selection objects may be output.

Further, in this embodiment, an information processing device that outputs list information together with map information will be described.

Furthermore, in this embodiment, an information processing device that performs beneficiary processing, which is processing related to beneficiaries of moving images, will be described. The beneficiary processing is, for example, reward processing described later and various conservation processing described later.

It is noted that in the present specification, information X being associated with information Y means that information Y may be acquired from information X, or information X may be acquired from information Y, and the method of association does not matter. Information X and information Y may be linked, may exist in the same buffer, information X may be included in information Y, information Y may be included in information X, etc.

### <Overview of Information System A>

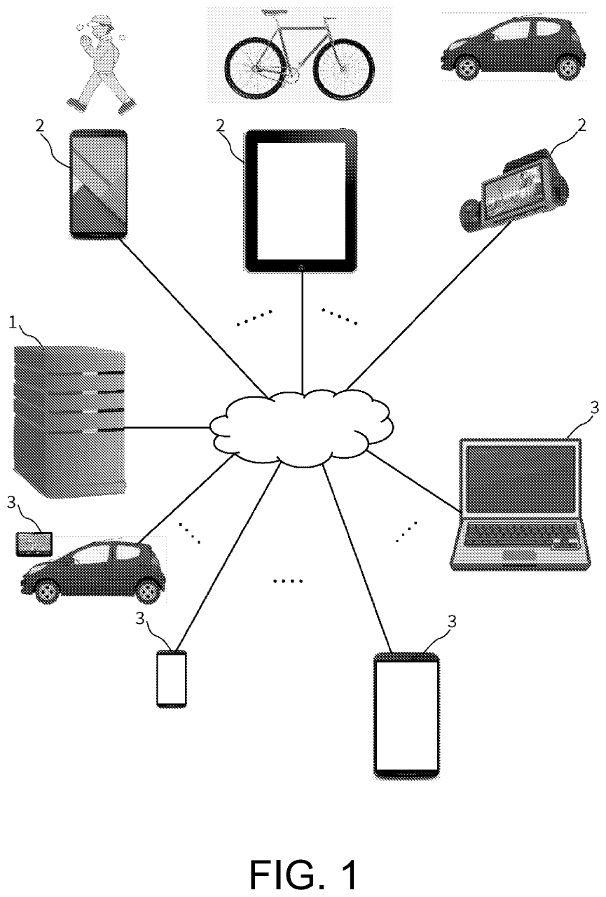

FIG. 1 is a conceptual diagram of an information system A in this embodiment. The information system A includes an information processing device 1, one or multiple mobile terminals 2, and one or multiple user terminals 3.

The information processing device 1 is a device that transmits moving images to the user terminal 3. The information processing device 1 is typically a server that provides moving images to the user terminal 3. The information processing device 1 is, for example, a cloud server, an ASP server, etc., but the type does not matter. The information processing device 1 may be a device that constitutes a blockchain.

It is noted that the information processing device 1 may be a standalone device. In the case of the information processing device 1 being a standalone device, the information system A does not have the user terminal 3.

Further, the intervals between shooting times of multiple still images included in the moving images in the present specification do not matter. The moving images are, for example, 60 frames/second moving images or 30 frames/second moving images, but may also be a set of multiple still images shot with intervals of a predetermined time (e.g., 1 minute) or more, or may be a set of multiple still images shot according to predetermined conditions being satisfied. The still images may also be referred to as fields or frames.

The mobile terminal 2 is a terminal that may move. The mobile terminal 2 is a device that shoots moving images and transmits the same to the information processing device 1. The mobile terminal 2 is a terminal installed on a mobile object and is a terminal that shoots the moving images. The mobile terminal 2 is, for example, a smartphone, a tablet terminal, a camera with communication function, glasses with a camera, a smartwatch with a camera, or a drive recorder. Further, installation typically means being fixed, but may also be considered to include the degree of being in contact with or being held. It is noted that a mobile object is an object that moves, for example, an automobile, a motorcycle, a bicycle, or a living being. A living being is typically a person, but may be other living beings.

The user terminal 3 is a terminal used by a user. The user terminal 3 is, for example, a device for outputting moving images of a route along which the user moves during the user's movement and supporting the user's movement to a destination. A user is a person who views moving images or a person who needs moving images. The user terminal 3 may have the function of the mobile terminal 2. That is, the user terminal 3 may be a terminal of a user who provides moving images. The user terminal 3 is, for example, a navigation terminal, a smartphone, a tablet terminal, a so-called personal computer, a navigation terminal, etc., and the type does not matter.

The information processing device 1 and one or more mobile terminals 2, and information processing device 1 and one or more user terminals 3 may typically communicate via a network such as the Internet.

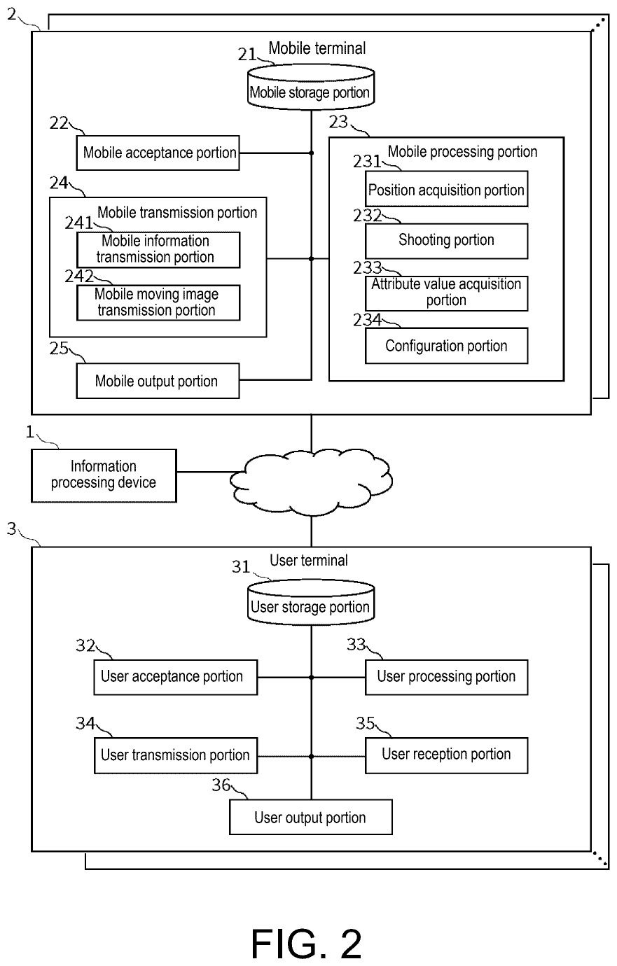

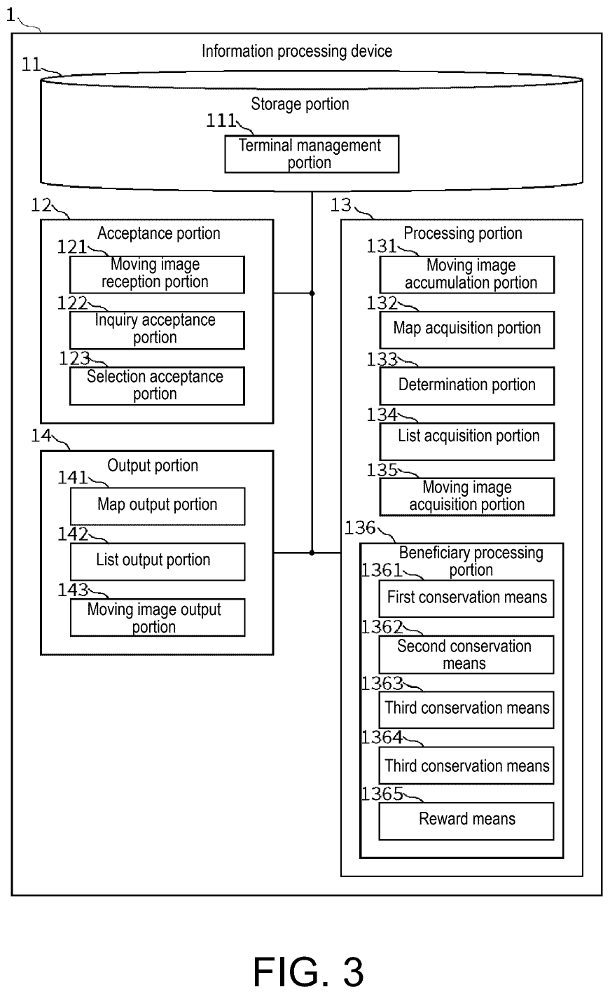

FIG. 2 is a block diagram of the information system A in this embodiment. FIG. 3 is a block diagram of the information processing device 1.

The information processing device 1 includes a storage portion 11, an acceptance portion 12, a processing portion 13, and an output portion 14. The storage portion 11 includes a terminal management portion 111. The acceptance portion 12 includes a moving image reception portion 121, an inquiry acceptance portion 122, and a selection acceptance portion 123. The processing portion 13 includes a moving image accumulation portion 131, a map acquisition portion 132, a determination portion 133, a list acquisition portion 134, a moving image acquisition portion 135, and a beneficiary processing portion 136. The beneficiary processing portion 136 includes a first conservation means 1361, a second conservation means 1362, a third conservation means 1363, a fourth conservation means 1364, and a reward means 1365. The output portion 14 includes a map output portion 141, a list output portion 142, and a moving image output portion 143.

The mobile terminal 2 includes a mobile storage portion 21, a mobile acceptance portion 22, a mobile processing portion 23, a mobile transmission portion 24, and a mobile output portion 25. The mobile processing portion 23 includes a position acquisition portion 231, a shooting portion 232, an attribute value acquisition portion 233, and a configuration portion 234.

The user terminal 3 includes a user storage portion 31, a user acceptance portion 32, a user processing portion 33, a user transmission portion 34, a user reception portion 35, and a user output portion 36.

### <Details of Components of Information Processing Device 1>

The storage portion 11 stores various types of information. The various types of information are, for example, terminal information described later, moving images associated with the terminal information, one or multiple attribute values associated with the moving images, map information, and selection conditions. It is noted that the attribute values are, for example, moving image attribute values.

The moving image attribute values are attribute values of moving images. The moving image attribute values are, for example, environmental information. Environmental information is information regarding the environment in which the moving image was shot. Environmental information is, for example, position information, time information, weather information, temperature information, season information, and road attribute values. Position information is information that specifies a position. Position information is, for example, (latitude, longitude) or (latitude, longitude, altitude). Time information is information that specifies the time at which the moving image was shot. The time at which the moving image was shot may be a time around the time when the moving image was shot, and accuracy may not be required. Time information is, for example, time, year/month/day/hour, year/month/day/hour/minute, year/month/day/hour/minute/second, year/month/day, or month/day. In other words, the granularity of the time indicated by the time information does not matter. Weather information is information that specifies the weather at the time of shooting at the location (which may be a region) where the moving image was shot. Weather information is, for example, “sunny,” “rainy,” “snowy,” or “cloudy”. Temperature information is information that specifies the air temperature at the time of shooting at the location where the moving image was shot. Temperature information is, for example, “25 degrees” or “30 degrees or higher”. Season information is information that specifies the season at the time of shooting at the location where the moving image was shot. Season information is, for example, “spring,” “summer,” “early summer,” or “winter”.

Road attribute values are attribute values of roads through which the mobile terminal 2 has passed or attribute values of the current position of the mobile terminal 2. Road attribute values are, for example, road type, road name, road width, presence or absence of sidewalks, presence or absence of traffic congestion, degree of traffic congestion, and location information. The road on which the mobile terminal 2 moved may also be said to be, for example, the road that was shot or the road on which the photographer moved. The degree of traffic congestion may also be called congestion level or crowding level. Location information is information that specifies a location. Location information is usually position information. Location information is, for example, location name or location ID.

Map information is used, for example, to acquire location information corresponding to position information and road attribute values corresponding to position information. Map information is, for example, in KIWI format, but the data structure does not matter.

The terminal management portion 111 stores one or multiple pieces of terminal information. The terminal information is information regarding the mobile terminal 2. The terminal information here usually includes a terminal identifier that is an identifier of the mobile terminal 2 and terminal communication information. The terminal information usually includes one or more attribute values. The attribute values are, for example, moving image attribute values. The mobile terminal 2 here is usually a terminal capable of transmitting moving images. The terminal information is associated with the mobile terminal 2.

The terminal identifier is information that identifies the mobile terminal 2. The terminal identifier may be a beneficiary identifier that identifies a beneficiary who is a user of the mobile terminal 2. The terminal identifier is, for example, an ID of the mobile terminal 2, a user identifier of a user of the mobile terminal 2, a name of the mobile terminal 2, an IP address of the mobile terminal 2, or a MAC address of the mobile terminal 2.

The beneficiary is a person who has some rights regarding moving images shot by the mobile terminal 2. The beneficiary is, for example, an owner of the moving image, a copyright holder of the moving image, an owner of the mobile terminal 2 that shot the moving image, or a person with disposal rights of the moving image. The beneficiary is, for example, an initial rights holder of the moving image. The beneficiary is usually a holder of the mobile terminal 2, but may be any person who has rights to the moving images shot by the mobile terminal 2.

The beneficiary identifier may be a terminal identifier. The beneficiary identifier is, for example, an ID of the beneficiary, a name of the beneficiary, an email address of the beneficiary, or a telephone number of the beneficiary. The ID of the beneficiary is, for example, a user identifier.

The terminal communication information is information for communicating with the mobile terminal 2. The terminal communication information is, for example, an IP address of the mobile terminal 2, a MAC address of the mobile terminal 2, or an ID of a communication application installed on the mobile terminal 2.

The terminal information may have route information that specifies a route along which the mobile terminal 2 moves. The route information usually includes multiple pieces of location information. The route information usually includes destination information. The route information includes, for example, departure point information. The destination information is information that specifies a destination. The destination information is an example of location information. The destination information may be simply referred to as a destination. The departure point information is information that specifies a departure point. The departure point information is an example of location information. The departure point information may be simply referred to as a departure point.

The acceptance portion 12 accepts various types of information and instructions. The various types of information and instructions are, for example, an attribute value set, a moving image, a query described later, a selection instruction described later, and a purchase instruction described later. An attribute value set is one or multiple attribute values. The attribute value set includes moving image attribute values.

Here, acceptance is usually reception of information transmitted via a wired or wireless communication line. However, acceptance may be a concept that includes acceptance of information input from input devices such as a keyboard, mouse, or touch panel, acceptance of information read from recording media such as optical disks, magnetic disks, or semiconductor memory, and the like.

The moving image reception portion 121 receives a moving image from the mobile terminal 2. The moving image reception portion 121 usually receives a moving image associated with a beneficiary identifier from the mobile terminal 2. It is preferable that one or multiple attribute values are associated with the moving image received from the mobile terminal 2. A moving image associated with one or multiple attribute values is an additional moving image.

The inquiry acceptance portion 122 accepts a query. The inquiry acceptance portion 122 receives, for example, a query from the user terminal 3. The query is a query for configuring the list information. The query includes information for determining the mobile terminal 2. The query includes, for example, area information. The query includes, for example, one or multiple pieces of route information. The query includes, for example, one or multiple pieces of location information. The query may have a destination. The query may have a departure point and a destination.

The selection acceptance portion 123 accepts a selection instruction. The selection instruction is an instruction for selecting one selection object from a list. The list is a user interface configured using list information.

The selection acceptance portion 123 usually receives a selection instruction from the user terminal 3. Such a selection instruction has, for example, an object identifier that specifies one selection object. The object identifier may be a moving image identifier that identifies a moving image. The object identifier may be a terminal identifier that identifies the mobile terminal 2.

A list is a list of moving images. The list is usually a user interface for selecting one moving image from multiple moving images. A list that is a user interface is a set of multiple selection objects. A selection object may be a button, a checkbox, or a menu item. In other words, the form of the list does not matter. The multiple selection objects that the list has need only be selectable by a user. The list information is information for configuring a list.

The processing portion 13 performs various types of processing. The various types of processing are, for example, processing performed by the moving image accumulation portion 131, the map acquisition portion 132, the determination portion 133, the list acquisition portion 134, the moving image acquisition portion 135, and the beneficiary processing portion 136.

The moving image accumulation portion 131 accumulates moving images received by the moving image reception portion 121 from the mobile terminal 2. It is preferable that the moving image accumulation portion 131 accumulates the moving image in association with a beneficiary identifier associated with the received moving image. The moving image accumulation portion 131 accumulates, for example, moving images in the storage portion 11, but may accumulate moving images in a blockchain or an external device.

The map acquisition portion 132 acquires map information that specifies positions of multiple mobile terminals 2. Such multiple mobile terminals 2 correspond to selection objects that the list information has.

The determination portion 133 determines multiple mobile terminals 2 that match the selection conditions. The determination portion 133 performs, for example, either of the following processing: (1) uses attribute value sets continuously transmitted from the mobile terminals 2 to determine the mobile terminals 2 that match the selection conditions, or (2) transmits queries to the mobile terminals 2 capable of transmitting moving images and determines the mobile terminals 2 that are determined to be capable of transmitting moving images matching the queries.

(1) In the Case of Determining the Mobile Terminals 2 that Match the Selection Conditions using Attribute Value Sets

The determination portion 133, for example, refers to the terminal management portion 111, and determines multiple mobile terminals 2 that match the selection conditions. The determination portion 133, for example, refers to the terminal management portion 111 and determines multiple mobile terminals 2 that are capable of transmitting moving images and match the selection conditions. The determination portion 133 usually refers to position information of each mobile terminal 2 and determines the mobile terminals 2 at positions that match the selection conditions. The mobile terminals 2 that match the selection conditions are usually the mobile terminals 2 corresponding to the accepted queries.

The selection conditions are conditions for determining the mobile terminals 2. The selection conditions are, for example, that the mobile terminal 2 corresponds to the terminal information including position information indicating a position within an area indicated by the area information included in a query. The selection conditions are, for example, that the mobile terminal 2 is moving along a route specified by the route information included in a query. The selection conditions are, for example, that the mobile terminal 2 is moving within an area in a range within a threshold from a position specified by position information or location information included in a query. The selection conditions are, for example, that the mobile terminal 2 is moving at a distance within a threshold or less than a threshold with respect to a POI in a range within a threshold from a position specified by position information or location information included in a query. The selection conditions are, for example, that location information included in destination information or route information corresponding to the mobile terminal 2 satisfies related conditions with respect to destination information included in a query accepted by the inquiry acceptance portion 122. The related conditions are, for example, matching, or that distance is within a threshold or less than a threshold.

(2) In the Case of Transmitting Queries to the Mobile Terminals 2 Capable of Transmitting Moving Images and Determining the Mobile Terminals 2 that are Determined to be Capable of Transmitting Moving Images Matching the Queries

The determination portion 133, for example, refers to the terminal management portion 111 and transmits queries to the mobile terminals 2 capable of transmitting moving images. Then, the determination portion 133 receives notification that moving images may be transmitted or receives moving images from the mobile terminals 2 that are determined to be capable of transmitting moving images matching the queries.

The list acquisition portion 134 acquires list information. The list information is information for configuring a list including one or multiple selection objects. The selection object is an object for selecting a moving image.

The list acquisition portion 134, for example, acquires one or more road attribute values of the mobile terminal 2 for each of multiple mobile terminals 2 determined by the determination portion 133 and configures selection objects including the one or more road attribute values. Then, the list acquisition portion 134 acquires list information including multiple selection objects. It is noted that the list acquisition portion 134, for example, acquires one or more road attribute values of the mobile terminal 2 from the terminal management portion 111 for each of multiple mobile terminals 2 determined by the determination portion 133, and acquires the list information including the selection objects including the one or more road attribute values. The selection objects are objects selectable by a user of the user terminal 3. The selection objects may include moving images or thumbnail images based on moving images.

The moving image acquisition portion 135 acquires a moving image associated with one selection object for a selection instruction accepted by the selection acceptance portion 123. It is preferable that the moving image acquired by the moving image acquisition portion 135 is an additional moving image. It is preferable that position information is associated with frames configuring the additional moving image.

The moving image acquisition portion 135 may acquire moving images shot previously that are associated with one selection object. The moving image acquisition portion 135 may acquire moving images shot previously that are associated with one selection object in response to receiving an instruction from the user terminal 3, or may acquire moving images shot previously in addition to the latest moving image without an instruction from the user terminal 3. The instruction from the user terminal 3 here is, for example, a rewind instruction.

The moving image acquired by the moving image acquisition portion 135 is, for example, (1) a moving image that the mobile terminal 2 transmits constantly, or (2) a moving image received from the mobile terminal 2 by transmitting a transmission instruction to the mobile terminal 2. The following describes these two cases.

(1) In the Case of Acquiring Moving Images that the Mobile Terminal 2 Transmits Constantly

The moving image acquisition portion 135, for example, acquires moving images from the storage portion 11. It is noted that the moving image acquisition portion 135 may acquire moving images from an external device not shown. The moving image acquisition portion 135, for example, acquires accumulated moving images that are paired with a terminal identifier included in a selection instruction accepted by the selection acceptance portion 123.

(2) In the Case of Acquiring Moving Images Received from the Mobile Terminal 2 by Transmitting a Transmission Instruction to the Mobile Terminal 2

The moving image acquisition portion 135, for example, transmits a transmission instruction to the mobile terminal 2 identified by a terminal identifier included in a selection instruction accepted by the selection acceptance portion 123. Then, the moving image acquisition portion 135 receives a moving image from the mobile terminal 2 in response to transmitting the transmission instruction.

The beneficiary processing portion 136 performs the beneficiary processing. The beneficiary processing is a processing related to a beneficiary identified by a beneficiary identifier associated with a moving image. It is noted that the moving image here is, for example, a moving image acquired by the moving image acquisition portion 135. The moving image here is, for example, a moving image received by the moving image reception portion 121.

The beneficiary processing portion 136, for example, performs the beneficiary processing that is a processing in response to the moving image output portion 143 transmitting a moving image and is a processing related to a beneficiary identified by a beneficiary identifier associated with the moving image. The beneficiary processing is, for example, a first conservation processing described later, a second conservation processing described later, a third conservation processing described later, a fourth conservation processing described later, and a reward processing described later.

It is noted that a beneficiary identifier associated with one moving image is, for example, a beneficiary identifier corresponding to the mobile terminal 2 that transmitted the moving image, or a user identifier of a user of the user terminal 3 to which the moving image was transmitted. The user of the user terminal 3 is a user of the user terminal 3 that transmitted the query.

The first conservation means 1361 performs the first conservation processing that accumulates moving images received by the moving image reception portion 121 in association with the attribute value sets corresponding to the moving images. It is noted that an attribute value set includes one or multiple attribute values. The first conservation means 1361, for example, accumulates moving images in a blockchain.

The second conservation means 1362 performs the second conservation processing that accumulates moving images received by the moving image reception portion 121 in association with the beneficiary identifiers corresponding to the moving images. The second conservation means 1362, for example, accumulates moving images in a blockchain.

The third conservation means 1363 accumulates moving images output by the moving image output portion 143 in association with the beneficiary identifiers that identify users of the user terminal 3 that requested the moving images. The third conservation means 1363, for example, accumulates the beneficiary identifiers that identify users of the user terminal 3 in association with the moving images. The third conservation means 1363, for example, accumulates the beneficiary identifiers in the storage portion 11 or a blockchain.

It is noted that the destination where the moving images are accumulated is, for example, the storage portion 11, but may also be other devices, other devices constituting a blockchain, etc.

The fourth conservation means 1364 performs the fourth conservation processing that accumulates conservation information. The conservation information includes access information for accessing the accumulated moving images. The order of accumulating the moving images and the fourth conservation processing for conservation information corresponding to the moving images does not matter.

The fourth conservation means 1364, for example, performs the fourth conservation processing that accumulates the conservation information including the access information for accessing the moving images acquired by the moving image acquisition portion 135 in a blockchain.

It is noted that it is preferable for the fourth conservation means 1364 to accumulate the conservation information in a blockchain. That is, it is preferable for the fourth conservation means 1364 to accumulate the conservation information in a distributed ledger of a blockchain. It is preferable for the fourth conservation means 1364 to register the conservation information as an NFT (non-fungible token). It is preferable for the fourth conservation means 1364 to register the conservation information in a distributed file system in an IPFS (Inter Planetary File System) network.

The conservation information is information for ensuring the originality of moving images. The conservation information may be said to be header information of the moving images. The conservation information is, for example, access information and an attribute value set. It is preferable for the conservation information to have, for example, one or multiple beneficiary identifiers. In the case of the conservation information having multiple beneficiary identifiers, the beneficiaries of the moving image may be shared, or the multiple beneficiary identifiers may be beneficiary history information. The beneficiary history information is a set of beneficiary identifiers and is information showing the history of beneficiaries. The fourth conservation processing may ensure the originality of the conservation information of registered moving images. By ensuring the originality of the conservation information, the originality of moving images corresponding to the conservation information is also ensured. It is noted that access information is information for accessing moving images. The access information is information that specifies the accumulation destination of moving images. The access information is, for example, a URL or URI.

It is preferable for the conservation information to include information (which may be called a flag) indicating whether or not the moving images may be provided to third parties. The flag is, for example, information indicating that third parties may view, information indicating that sales are possible, or information indicating that neither viewing nor sales are permitted.

The reward means 1365 performs reward processing for each beneficiary identified by a beneficiary identifier associated with the moving images acquired by the moving image acquisition portion 135.

The reward means 1365, for example, performs reward processing also for beneficiaries of one or more selection objects corresponding to the moving images that are the mobile terminal 2 corresponding to the selection objects and are not the moving images acquired by the moving image acquisition portion 135. That is, it is preferable for the reward means 1365 to perform reward processing also for beneficiaries of the moving images that became selection candidates but were not selected. However, it is preferable for the reward means 1365 to make the rewards for the beneficiaries of the moving images that became the selection candidates but were not selected lower than the rewards for the beneficiaries of selected moving images.

The reward processing is a processing that gives rewards. The reward processing is, for example, a processing that increases points managed in pairs with one or multiple beneficiary identifiers associated with the moving images. The reward processing is, for example, processing that deposits money to beneficiaries identified by one or multiple beneficiary identifiers associated with moving images. The reward processing is, for example, processing that transmits moving images or other content to the user terminal 3 of the beneficiaries identified by one or multiple beneficiary identifiers associated with the moving images. The reward processing is acceptable as long as benefits are given to beneficiaries identified by one or multiple beneficiary identifiers associated with the moving images, and the content does not matter. Further, rewards are, for example, money, points, goods, content, etc., and the content does not matter.

It is preferable for the reward means 1365 to acquire one or multiple moving image attribute values corresponding to moving images transmitted by moving image output portion 143, determine rewards for the beneficiaries using the one or more moving image attribute values, and perform reward processing which is processing that gives rewards.

The one or more moving image attribute values here are, for example, data amount of moving images, time of moving images, number of frames of moving images, resolution of moving images, and road attribute values. The road attribute values here are, for example, rarity of the location and attractiveness of the location. The rarity of locations and attractiveness of locations are, for example, included in the map information in association with the location information or the road identifiers.

It is preferable for the reward means 1365 to acquire a reward amount corresponding to a service identifier that identifies a service performed on a target moving image, and perform reward processing which is processing that gives rewards corresponding to the reward amount. It is noted that the service identifier is, for example, “viewing” or “purchase”. In such cases, for example, the storage portion 11 stores reward amounts corresponding to the service identifiers, or information for determining reward amounts corresponding to the service identifiers.

The reward means 1365, for example, acquires a reward amount using one or multiple pieces of information among one or multiple moving image attribute values and service identifiers, and performs reward processing which is a processing that gives rewards corresponding to the reward amount. In such cases, for example, the storage portion 11 stores calculation formulas or correspondence tables corresponding to the multiple service identifiers. The calculation formula is a formula that calculates the reward amounts using one or multiple moving image attribute values as parameters. The correspondence table is a table having multiple pieces of correspondence information that manage the reward amounts corresponding to one or multiple moving image attribute values.

The reward means 1365 usually performs processing to make users who enjoyed services related to target moving images bear rewards. The processing to make users bear rewards is, for example, processing to make users bear the amount of acquired reward amounts. The processing to make users bear rewards is, for example, processing to make users bear the amount of acquired reward amounts and the amount of profit obtained by the operating side of the information processing device 1. The processing to make users bear rewards is, for example, processing to reduce points corresponding to users who enjoyed services, payment processing using credit card numbers of the users, etc.

The output portion 14 outputs various information or instructions. Here, output is usually transmission to the mobile terminal 2 or the user terminal 3, but may be a concept that includes display on a display, projection using a projector, printing with a printer, accumulation on recording medium, delivery of processing results to other processing devices or other programs, etc.

The output portion 14, for example, transmits various information or instructions to the mobile terminal 2 or the user terminal 3. The various information or instructions are, for example, the list information and the moving images.

The map output portion 141 outputs the map information in the case of the list information being output. The map output portion 141, for example, transmits the map information to the user terminal 3. It is preferable for the map output portion 141 to output map information that clearly indicates position information of the mobile terminal 2 corresponding to the selection objects included in the list information on a map. It is preferable for the map output portion 141 to output map information that clearly indicates position information of the mobile terminal 2 corresponding to the selection objects selected by a user on a map. It is noted that the selection objects that configure the list information may be objects that appear on the map.

The list output portion 142 outputs the list information configured by the list acquisition portion 134. The list output portion 142 usually transmits the list information to the user terminal 3 that transmitted the query. The output of the list information may be output of a list based on the list information.

The moving image output portion 143 outputs the moving image acquired by the moving image acquisition portion 135. The moving image output portion 143 transmits the moving image to the user terminal 3 that transmitted the selection instruction.

### <Details of Components of Mobile Terminal 2>

Various information is stored in the mobile storage portion 21. The various information is, for example, moving images, attribute value sets, beneficiary identifiers, camera attribute values, and map information. The camera attribute values are attribute values of cameras. The camera attribute values are, for example, angle of view, direction information, and resolution.

One or more still images that configure a moving image are associated with, for example, one or more moving image attribute values that configure an attribute value set. The one or more moving image attribute values may be associated with all still images, may be associated with some still images, or may be associated with multiple still images.

A mobile acceptance portion 22 accepts various information and instructions. The various information and instructions are, for example, start instructions, transmission instructions, and queries. A start instruction is an instruction to start operation. A transmission instruction is an instruction to transmit a moving image.

The mobile acceptance portion 22 accepts, for example, a start instruction from a user of the mobile terminal 2. The mobile acceptance portion 22 receives, for example, a transmission instruction from the information processing device 1. The mobile acceptance portion 22 receives, for example, a query from the information processing device 1.

It is noted that the acceptance here refers to accepting information input from input devices such as keyboards, mouses, and touch panels, and receiving information transmitted via wired or wireless communication lines, but may also be a concept that includes accepting information read from recording media such as optical disks, magnetic disks, and semiconductor memories.

The mobile processing portion 23 performs various processing. The various processing is, for example, processing performed by the position acquisition portion 231, the shooting portion 232, the attribute value acquisition portion 233, and the configuration portion 234.

The mobile processing portion 23, for example, in the case of the mobile acceptance portion 22 receiving a query, determines whether or not the position information acquired by the position acquisition portion 231 matches the query. In the case of the position information matching the query, for example, the distance between a position indicated by the position information and a position specified by any location information included in the query is within a threshold or less than a threshold. In the case of the position information matching the query, for example, a road corresponding to the position information is any road of a route specified by the route information included in the query.

The position acquisition portion 231 acquires the position information. The position acquisition portion 231 normally acquires the position information that specifies a position of the mobile terminal 2. The position acquisition portion 231 acquires a current position. The position acquisition portion 231 acquires the position information by, for example, a GPS receiver. However, the means, algorithm, etc., by which the position acquisition portion 231 acquires the position information does not matter. It is noted that the current position is the position information that specifies a current position.

The shooting portion 232 shoots a moving image. The shooting portion 232 shoots a moving image, for example, while the mobile terminal 2 is moving. It is noted that it is preferable that the position information acquired by the position acquisition portion 231 is associated with the shot moving image. It is preferable that one or more attribute values acquired by the attribute value acquisition portion 233 described later are associated with the shot moving image.

It is preferable that the shooting portion 232 accumulates the shot moving image in the mobile storage portion 21. In the case of the shooting portion 232 accumulating a moving image in the mobile storage portion 21 with limited storage capacity, it is preferable to overwrite a new moving image in an area where an old moving image is stored. That is, it is preferable that the structure of the mobile storage portion 21 is a ring buffer structure.

The attribute value acquisition portion 233 acquires one or more camera attribute values including direction information indicating a direction in which the shooting portion 232 shoots. It is preferable that the attribute value acquisition portion 233 acquires one or multiple moving image attribute values including the camera attribute values.

The attribute value acquisition portion 233 acquires, for example, one or more attribute values. One or multiple attribute values may be referred to as an attribute value set. The attribute value acquisition portion 233 acquires, for example, one or more attribute values during shooting. The attribute value acquisition portion 233 acquires one or more attribute values, for example, constantly, at predetermined intervals, or in the case of satisfying acquisition conditions.

The attribute value acquisition portion 233 acquires, for example, time information from a clock not shown. The attribute value acquisition portion 233 acquires, for example, time information from a clock not shown and acquires season information corresponding to the time information. The mobile processing portion 23 acquires, for example, weather information corresponding to the position information from a server not shown. The attribute value acquisition portion 233 acquires, for example, temperature information. The mobile processing portion 23 acquires, for example, temperature information corresponding to the position information from a server not shown. The mobile processing portion 23 acquires, for example, temperature information from a temperature sensor installed in a mobile object. It is noted that the acquisition conditions are, for example, in the case of an analysis result of a moving image satisfying a predetermined condition, or in the case of a moving image attribute value satisfying a predetermined condition. The predetermined conditions are, for example, being in traffic congestion or an accident having occurred.

The attribute value acquisition portion 233 acquires, for example, road attribute values corresponding to the position information acquired by the position acquisition portion 231 from the map information, and associates the road attribute values with the moving image. The attribute value acquisition portion 233 acquires, for example, the location information corresponding to the position information acquired by the position acquisition portion 231 from the map information, and associates the location information with the moving image. The attribute value acquisition portion 233 acquires, for example, the location information corresponding to the position information acquired by the position acquisition portion 231 and having specific conditions from the map information, and associates the location information with the moving image. The specific conditions are, for example, that the location information is a specific type of location information (e.g., station name, building name).

It is noted that associating with a moving image may be associating with frames constituting the moving image, or may be associating with the entire moving image.

The attribute value acquisition portion 233 acquires, for example, one or more tags for a moving image shot by the shooting portion 232, and associates the same with the moving image. It is noted that the tags may also be said to be attribute values.

The attribute value acquisition portion 233 analyzes, for example, a moving image shot by the shooting portion 232, and acquires one or more tags for the moving image.

The attribute value acquisition portion 233 acquires, for example, one or more tags using one or multiple mobile object attribute values acquired during shooting by the shooting portion 232. The mobile object attribute values are, for example, CAN data.

The attribute value acquisition portion 233 determines, for example, one or more still images that match the moving image tag conditions, and acquires tags paired with the moving image tag conditions. Further, the attribute value acquisition portion 233 may associate the tags with the one or more still images. It is noted that still images are frames constituting a moving image.

For example, in the case where the moving image tag condition is “the number of automobiles with front-to-rear intervals within a threshold is equal to or greater than a threshold & the moving speed of automobiles is equal to or less than a threshold” and the tag paired with the moving image tag condition is “traffic jam”, the attribute value acquisition portion 233 analyzes frames included in the moving image, recognizes multiple automobiles, and acquires intervals between each of the multiple automobiles. Further, the attribute value acquisition portion 233 acquires the number of automobiles whose intervals are within the threshold. Further, the attribute value acquisition portion 233 acquires the moving distance of one automobile in multiple frames and the frame rate, and acquires the speed of the automobile. Then, the attribute value acquisition portion 233 uses the number of automobiles whose intervals are within the threshold and the speed of the automobiles to determine whether the moving image tag condition is matched. Then, in the case where the moving image tag condition is matched, the attribute value acquisition portion 233 acquires the tag “traffic jam” paired with the moving image tag condition. Further, the attribute value acquisition portion 233 may associate the tag “traffic jam” with the analyzed frames of the analyzed moving image.

The attribute value acquisition portion 233 determines, for example, one or more mobile object attribute values that match the attribute value tag conditions, and acquires tags paired with the attribute value tag conditions. Further, the attribute value acquisition portion 233 may associate the tags with the moving images paired with the one or more mobile object attribute values.

For example, in the case where the attribute value tag condition is “driving time at speed less than 30 km is 10 minutes or more & the ratio of speed less than 30% during the driving time is 80% or more” and the tag paired with the attribute value tag condition is “traffic jam”, the attribute value acquisition portion 233 uses the speed history included in the CAN data associated with each field included in the moving image to detect the CAN data that matches the attribute value tag condition, acquires the tag “traffic jam” paired with the attribute value tag condition, and associates the tag with the field corresponding to the CAN data. It is noted that the CAN data associated with each field included in the moving image is CAN acquired at the same timing as the timing at which the field was shot.

The configuration portion 234 associates the acquired position information with the moving image to acquire an additional moving image. The configuration portion 234 acquires, for example, an additional moving image in which one or more camera attribute values acquired by the attribute value acquisition portion 233 are also associated with the moving image. The configuration portion 234 acquires, for example, an additional moving image in which one or more attribute values acquired by the attribute value acquisition portion 233 are also associated with the moving image. The additional moving image is a moving image to which one or more attribute values are added. The one or more attribute values typically include the position information.

The mobile transmission portion 24 includes a mobile information transmission portion 241 and a mobile moving image transmission portion 242 and transmits various types of information to the information processing device 1. The various types of information are, for example, moving images, additional moving images, and attribute value sets. The mobile transmission portion 24 may continuously transmit moving images acquired by the shooting portion 232 to the information processing device 1. In such cases, the position information is typically associated with the moving images.

In the case where a transmission instruction is received, the mobile transmission portion 24 transmits, for example, an additional moving image to the information processing device 1.

In the case where a query is received and the mobile processing portion 23 determines that the query matches, the mobile transmission portion 24 transmits, for example, an additional moving image or an attribute value set to the information processing device 1.

The mobile output portion 25 outputs various types of information. The various types of information are, for example, moving images, additional moving images, and attribute value sets. Here, output is a concept that includes display on a display, projection using a projector, printing with a printer, audio output, transmission to external devices, accumulation on recording media, delivery of processing results to other processing devices or other programs, and the like.

### <Details of Components of User Terminal 3>

The user terminal 3 may have the same functions as the mobile terminal 2. The mobile terminal 2 and the user terminal 3 may mutually have the same functions.

The user storage portion 31 stores various types of information. The various types of information are, for example, user identifiers, moving images, queries, and map information.

The user acceptance portion 32 accepts various instructions and information. The various instructions and information are, for example, queries, selection instructions, purchase instructions, and destinations. It is noted that a query may have one or more moving image attribute values. Further, a selection instruction is an instruction for a selection object.

A purchase instruction is an instruction to purchase a moving image. The purchase instruction is associated with a user identifier. The purchase instruction usually includes information that specifies the moving image. The purchase instruction has, for example, a moving image identifier. The purchase instruction includes, for example, a query. The purchase instruction includes, for example, conditions for purchase. The conditions for purchase are, for example, a purchase amount. The conditions for purchase include, for example, information that specifies a rights period.

Acceptance is a concept that includes acceptance of information input from input devices such as keyboards, mouses, and touch panels, reception of information transmitted via wired or wireless communication lines, acceptance of information read from recording media such as optical disks, magnetic disks, and semiconductor memories, and the like.

The user processing portion 33 performs various types of processing. The various types of processing are, for example, processing to create a data structure for transmitting various instructions and information accepted by the user acceptance portion 32. The various types of processing are, for example, processing to create a structure for transmitting information received by the user reception portion 35.

The user processing portion 33 acquires the position information. Such position information is information indicating a current position. In such a case, the user processing portion 33 has, for example, a GPS receiver.

The user processing portion 33 implements, for example, known functions of a navigation terminal. The user processing portion 33, for example, reads the map information from the user storage portion 31. The user processing portion 33, for example, uses the accepted destination to acquire the route information and perform route setting.

The user processing portion 33 determines whether or not query conditions have been met. The query conditions are conditions for acquiring the list information of the moving images. The query conditions are, for example, that a destination has been input or set, that route information from a current position to a destination has been acquired, that the area information of the map information being output by the user output portion 36 has changed, that a query has been input from a user, that the user acceptance portion 32 has accepted a query, that congestion has been detected, or that an accident has been detected. It is noted that the query conditions are not limited.

The user processing portion 33 configures a query to be transmitted in the case of determining that query conditions have been met. The query is associated with a user identifier.

In the case of the query condition being that a destination has been input or set, the user processing portion 33 configures, for example, a query having the destination information, a query having the current position and the destination information, or a query having one or multiple route information from the current position to the destination.

In the case of the query condition being that the route information from the current position to the destination has been acquired, the user processing portion 33 configures, for example, a query having the route information from the current position to the destination.

In the case of the query condition being that the area information of the map information being output by the user output portion 36 has changed, the user processing portion 33 configures, for example, a query having the area information.

In the case of the query condition being that a query has been input from a user, the user processing portion 33 configures, for example, a query having the input information.

In the case of the query condition being that congestion has been detected or that an accident has been detected, the user processing portion 33 configures, for example, a query having the position information indicating the current position.

The user processing portion 33 configures a list to be output using the list information received from the information processing device 1. The user processing portion 33 may include a position acquisition portion that acquires the current position. The position acquisition portion acquires the position information by, for example, a GPS receiver, but the method of acquiring the position information is not limited.

The user transmission portion 34 transmits various instructions and information to the information processing device 1. The various instructions and information are, for example, queries, selection instructions, and purchase instructions.

The user reception portion 35 receives various instructions and information. The user reception portion 35 receives, for example, various instructions and information from the information processing device 1. The various instructions and information are, for example, the list information and the moving images.

The user output portion 36 outputs various information. The various information are lists, moving images, and maps. The user output portion 36 outputs, for example, a map using the map information of the user storage portion 31. It is preferable that the user output portion 36 outputs together a moving image corresponding to the current position and a map corresponding to the current position.

The user output portion 36 outputs, for example, a list based on the list information received by the user reception portion 35. The user output portion 36 outputs, for example, a moving image received by the user reception portion 35.

Here, output is a concept that includes display on a display, projection using a projector, printing with a printer, audio output, transmission to external devices, accumulation on recording media, delivery of processing results to other processing devices or other programs, and the like.

The storage portion 11, the terminal management portion 111, the mobile storage portion 21, and the user storage portion 31 are preferably non-volatile recording media, but may also be implemented with volatile recording media.

The process by which information is stored in the storage portion 11 and the like does not matter. For example, information may be stored in the storage portion 11 and the like via a recording medium, information transmitted via a communication line or the like may be stored in the storage portion 11 and the like, or information input via an input device may be stored in the storage portion 11 and the like.

The acceptance portion 12, the inquiry acceptance portion 122, and the selection acceptance portion 123 are preferably implemented by wireless or wired communication means, but may also be implemented by means for receiving broadcasts, device drivers for input means such as touch panels or keyboards, menu screen control software, and the like.

The moving image reception portion 121, the mobile acceptance portion 22, and the user reception portion 35 are usually implemented by wireless or wired communication means, but may also be implemented by means for receiving broadcasts.

The processing portion 13, the moving image accumulation portion 131, the map acquisition portion 132, the determination portion 133, the list acquisition portion 134, the moving image acquisition portion 135, the beneficiary processing portion 136, the first conservation means 1361, the second conservation means 1362, the third conservation means 1363, the fourth conservation means 1364, the reward means 1365, the mobile processing portion 23, the attribute value acquisition portion 233, the configuration portion 234, and the user processing portion 33 may usually be implemented by a processor, memory, and the like. The processing procedures of the processing portion 13 and the like are usually implemented by software, and the software is recorded on a recording medium such as ROM. However, they may also be implemented by hardware (dedicated circuits). It is noted that the processor is a CPU, MPU, GPU, or the like, and the type does not matter.

The output portion 14, the map output portion 141, the list output portion 142, and the moving image output portion 143 are usually implemented by wireless or wired communication means, but may also be implemented by driver software of an output device, or by driver software of an output device and the output device, and the like.

The position acquisition portion 231 is implemented by, for example, a GPS receiver.

The shooting portion 232 is implemented by a camera.

The mobile transmission portion 24 and the user transmission portion 34 are usually implemented by wireless or wired communication means, but may also be implemented by broadcasting means.

The mobile output portion 25 and the user output portion 36 may be considered to include or not include output devices such as displays and speakers. The user output portion 36 and the like may be implemented by driver software of an output device, or by driver software of an output device and the output device, and the like.

The user acceptance portion 32 may be implemented by device drivers of input means such as touch panels and keyboards, control software of menu screens, and the like.

### <Operation>

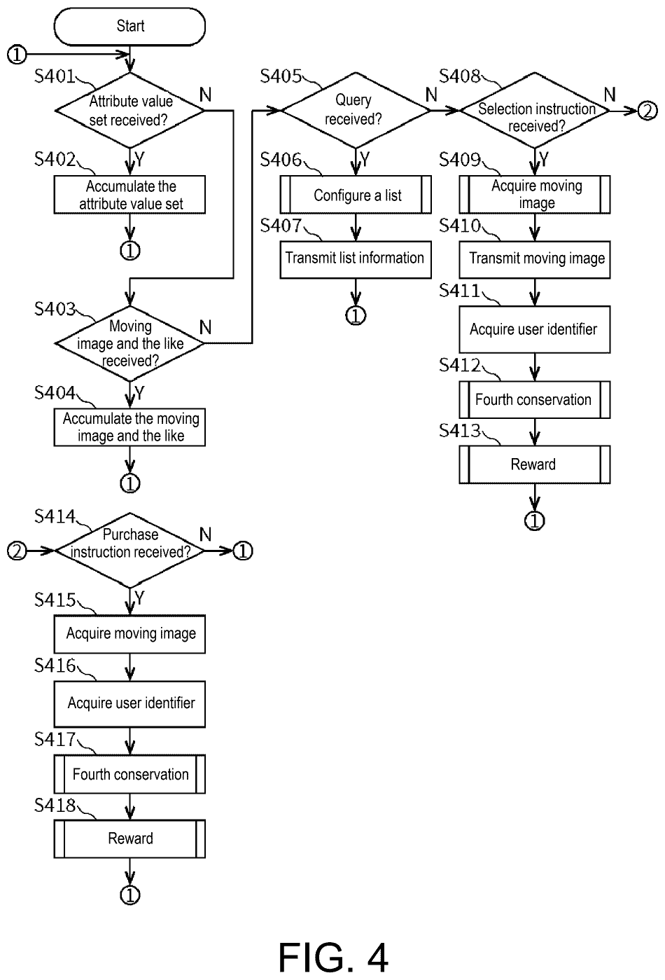

Next, an operation example of the information system A will be described. First, an operation example of the information processing device 1 will be described using the flowchart of FIG. 4.

(S401) The acceptance portion 12 determines whether or not an attribute value set has been received from the mobile terminal 2. In the case of receiving the attribute value set, the process goes to S402, and in the case of not receiving the attribute value set, the process goes to S403. It is noted that the attribute value set is associated with a terminal identifier.

(S402) The processing portion 13 accumulates the attribute value set received in S401 in the terminal management portion 111 in association with the terminal identifier. The process returns to S401.

(S403) The moving image reception portion 121 determines whether or not a moving image and the like have been received from the mobile terminal 2. In the case of receiving a moving image and the like, the process goes to S404, and in the case of not receiving a moving image and the like, the process goes to S405. It is noted that the moving image here is usually an additional moving image. Further, the moving image and the like are, for example, an additional moving image and a beneficiary identifier.

(S404) The moving image accumulation portion 131 accumulates the moving image and the like received in S403 in the storage portion 11. Further, the processing portion 13 accumulates an attribute value set corresponding to the moving image and the like received in S403 in the terminal management portion 111 in association with the terminal identifier. The process returns to S401. It is noted that the moving image accumulation portion 131, for example, acquires a unique moving image identifier and accumulates the moving image paired with the moving image identifier. The moving image accumulation portion 131, for example, accumulates the moving image in association with the received beneficiary identifier.

(S405) The inquiry acceptance portion 122 determines whether or not a query has been received from the user terminal 3. In the case of receiving a query, the process goes to S406, and in the case of not receiving a query, the process goes to S408. It is noted that the query has, for example, the destination information, the route information, or the area information of the map information. The area information is information that specifies an area of a map displayed on the user terminal 3.

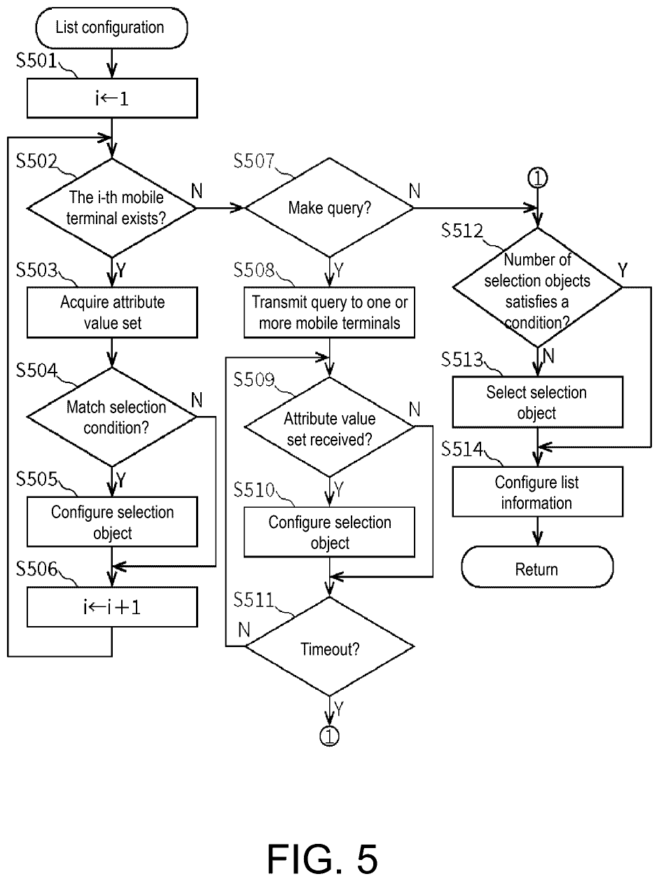

(S406) The list acquisition portion 134 configures list information for a user to select a moving image corresponding to the query received in S405. An example of such list configuration processing will be described using the flowchart of FIG. 5.

(S407) The list output portion 142 transmits the list information configured in S406 to the user terminal 3. The process returns to S401.

(S408) The selection acceptance portion 123 determines whether or not a selection instruction has been received from the user terminal 3. In the case of receiving a selection instruction, the process goes to S409, and in the case of not receiving a selection instruction, the process goes to S414.

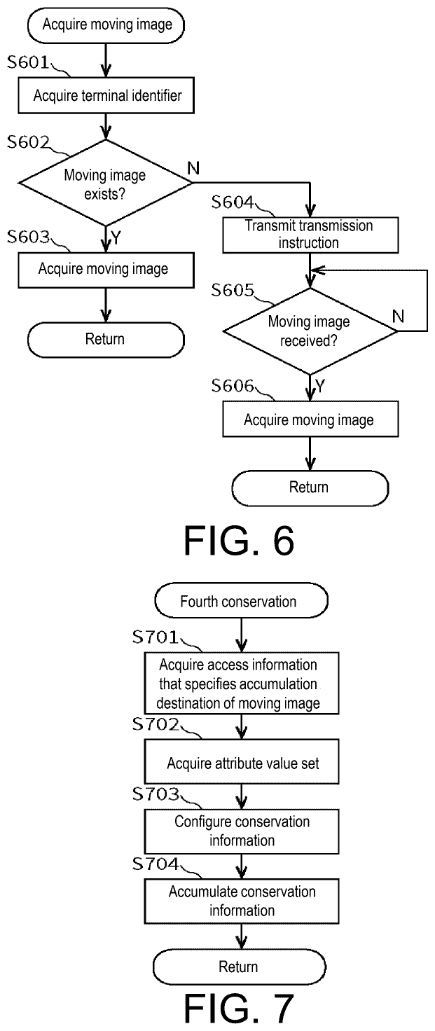

(S409) The moving image acquisition portion 135 acquires a moving image corresponding to the selection instruction received in S408. An example of such moving image acquisition processing will be described using the flowchart of FIG. 6.

(S410) The moving image output portion 143 transmits the moving image acquired in S409 to the user terminal 3. It is noted that it is preferable that position information is associated with each of multiple frames constituting the transmitted moving image. Further, in the case of transmitting a moving image shot by the mobile terminal 2 to the user terminal 3, it is preferable to continuously transmit to the user terminal 3 the moving image that the mobile terminal 2 shoots and transmits while not receiving an end instruction from the user terminal 3.

(S411) The fourth conservation means 1364 acquires a user identifier corresponding to the user terminal 3 that transmitted the selection instruction.

(S412) The fourth conservation means 1364 performs the fourth conservation processing using the user identifier acquired in S411. An example of the fourth conservation processing will be described using the flowchart of FIG. 7.

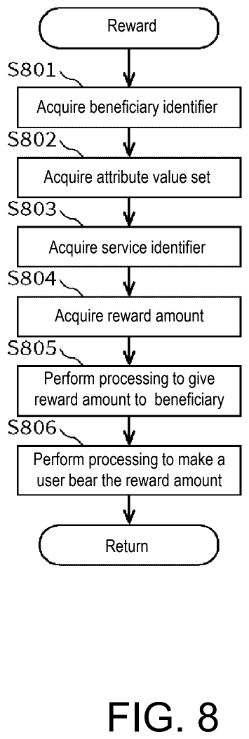

(S413) The reward means 1365 performs the reward processing for the original beneficiary of the moving image. The process returns to S401. An example of the reward processing will be described using the flowchart of FIG. 8.

(S414) The acceptance portion 12 determines whether or not a purchase instruction has been received from the user terminal 3. In the case of receiving a purchase instruction, the process goes to S415, and in the case of not receiving the purchase instruction, the process returns to S401.

(S415) The moving image acquisition portion 135 acquires a moving image corresponding to the purchase instruction received in S414. It is noted that the moving image acquisition portion 135 acquires, for example, a moving image corresponding to the purchase instruction from among the moving images accumulated by the moving image accumulation portion 131 in S404.

(S416) The fourth conservation means 1354 acquires a user identifier corresponding to the user terminal 3 that transmitted the purchase instruction. It is noted that this user identifier becomes a beneficiary identifier for the purchased moving image.

(S417) The fourth conservation means 1354 performs the fourth conservation processing using the user identifier acquired in S416. An example of the fourth conservation processing will be described using the flowchart of FIG. 7.

(S418) The reward means 1355 performs the reward processing for the original beneficiary of the moving image to be purchased. The process returns to S401. An example of the reward processing will be described using the flowchart of FIG. 8.

It is noted that in the flowchart of FIG. 4, the information processing device 1 may receive a viewing instruction for a moving image from the user terminal 3. In such a case, the information processing device 1 acquires a moving image corresponding to the viewing instruction and transmits the same to the user terminal 3. Further, in such a case, it is preferable that the information processing device 1 performs the reward processing for the beneficiary identified by the beneficiary identifier corresponding to the moving image.

Further, in the flowchart of FIG. 4, in the case of there being one moving image that matches the query, it is preferable that the list acquisition portion 134 does not configure the list information and the moving image output portion 143 transmits the moving image to the user terminal 3.

Furthermore, in the flowchart of FIG. 4, the processing ends due to interruption by power-off or processing termination.

Next, an example of the list configuration processing of S404 will be described using the flowchart of FIG. 5.

(S501) The list acquisition portion 134 substitutes 1 into counter i.

(S502) The list acquisition portion 134 determines whether or not the i-th mobile terminal 2 exists. In the case of the i-th mobile terminal 2 existing, the process goes to S503, and in the case of the i-th mobile terminal 2 not existing, the process goes to S507. Here, the list acquisition portion 134 determines, for example, whether or not the i-th terminal information exists in the terminal management portion 111.

(S503) The list acquisition portion 134 acquires the attribute value set of the i-th mobile terminal 2 from the terminal management portion 111.

(S504) The list acquisition portion 134 acquires the selection condition. The list acquisition portion 134 acquires, for example, the selection condition included in the received query. The list acquisition portion 134 determines whether or not the attribute value set acquired in S503 matches the selection condition. In the case of matching the selection condition, the process goes to S505, and in the case of not matching the selection condition, the process goes to S506.

(S505) The list acquisition portion 134 configures a selection object using one or more attribute values from the attribute value set of the i-th mobile terminal 2. Here, it is preferable that the one or more attribute values include road attribute values.

(S506) The list acquisition portion 134 increments counter i by 1. The process returns to S502.

(S507) The list acquisition portion 134 determines whether or not to make a query to one or more mobile terminals 2. In the case of making a query, the process goes to S508, and in the case of not making a query, the process goes to S512. It is noted that the list acquisition portion 134 determines to make a query to the one or more mobile terminals 2, for example, in the case of one or more mobile terminals 2 that have transmitted movement information indicating movement existing. It is noted that the movement information may also be said to be information indicating that the mobile terminal 2 is moving. The mobile terminal 2 that has transmitted the movement information indicating movement is in a state capable of transmitting the moving images.

(S508) The list acquisition portion 134 configures a query including the selection condition. The list acquisition portion 134 transmits the query to one or more mobile terminals 2. It is noted that the one or more mobile terminals 2 are, for example, mobile terminals 2 that have transmitted the movement information indicating movement.

(S509) The list acquisition portion 134 determines whether or not an attribute value set has been received from the mobile terminal 2. In the case of receiving an attribute value set, the process goes to S510, and in the case of not receiving an attribute value set, the process goes to S511. It is noted that in S509, the list acquisition portion 134 may also receive a moving image.

(S510) The list acquisition portion 134 configures a selection object using one or more attribute values from the attribute value set received in S509.

(S511) The list acquisition portion 134 determines whether or not a timeout has occurred. In the case of a timeout, the process goes to S512, and in the case of no timeout, the process returns to S509.

(S512) The list acquisition portion 134 determines whether or not the number of the configured selection objects satisfies a condition. In the case of satisfying the condition, the process goes to S514, and in the case of not satisfying the condition, the process goes to S513. It is noted that, for example, in the case of an upper limit being determined for the number of selection objects to be output, and in the case of selection objects exceeding that upper limit number being configured, the list acquisition portion 134 determines that the condition is not satisfied.

(S513) The list acquisition portion 134 selects selection objects to be output from among the configured selection objects. It is noted that the method by which the list acquisition portion 134 determines the selection objects to select does not matter.

(S514) The list acquisition portion 134 returns to the upper level processing that configures the list information including the acquired selection objects.

Next, an example of the moving image acquisition processing of S409 will be described using the flowchart of FIG. 6.

(S601) The moving image acquisition portion 135 acquires a terminal identifier corresponding to the selected selection object.

(S602) The moving image acquisition portion 135 determines whether or not a moving image paired with the terminal identifier acquired in S601 exists. In the case of the moving image existing, the process goes to S603, and in the case of the moving image not existing, the process goes to S604. It is noted that in the case of a moving image paired with the terminal identifier existing, this is normally the case of a moving image being transmitted from the mobile terminal 2 constantly or periodically.

(S603) The moving image acquisition portion 135 acquires a moving image paired with the terminal identifier. The process returns to the upper level processing. It is preferable that the moving image here also includes moving images shot previously.

(S604) The moving image acquisition portion 135 transmits a transmission instruction for a moving image to the mobile terminal 2 identified by the terminal identifier acquired in S601.

(S605) The moving image acquisition portion 135 determines whether or not a moving image has been received from the mobile terminal 2 to which the transmission instruction was transmitted. In the case of receiving a moving image, the process goes to S606, and in the case of not receiving a moving image, the process returns to S605.

(S606) The moving image acquisition portion 135 acquires the moving image received in S605. The process returns to the upper level processing. It is preferable that the acquired moving image also includes moving images that were previously accumulated in the mobile terminal 2. Further, it is preferable that the moving image accumulation portion 131 accumulates the acquired moving image here.

Next, an example of the fourth conservation processing of S412 and S417 will be described using the flowchart of FIG. 7.

(S701) The fourth conservation means 1364 acquires access information that specifies an accumulation destination of the moving image.

(S702) The fourth conservation means 1364 acquires an attribute value set corresponding to the accumulated moving image.

(S703) The fourth conservation means 1364 configures conservation information having the access information acquired in S701, the attribute value set acquired in S702, and a beneficiary identifier of the moving image. It is noted that in the case of a new beneficiary identifier being acquired, the fourth conservation means 1364 configures conservation information including, for example, the new beneficiary identifier and the original beneficiary identifier.

(S704) The fourth conservation means 1364 accumulates the conservation information configured in S703. The process returns to the upper level processing.

In S704, in the case of conservation information of a moving image corresponding to the conservation information to be accumulated being accumulated, the conservation information is overwritten with the conservation information configured in S703. By doing so, for example, transition of beneficiaries of the moving image may be managed. Further, the fourth conservation means 1364 accumulates the conservation information in, for example, a blockchain.

Next, an example of the reward processing of S413 and S418 will be described using the flowchart of FIG. 8.

(S801) The reward means 1365 acquires one or multiple beneficiary identifiers of the target moving image. The reward means 1365 may acquire beneficiary identifiers of previous beneficiaries of the target moving image.

(S802) The reward means 1365 acquires an attribute value set of the target moving image. It is noted that the target moving image is a moving image acquired by the moving image acquisition portion 135. It is preferable that the target moving image is a moving image to the destination acquired by the moving image acquisition portion 135.

(S803) The reward means 1365 acquires a service identifier that identifies a service performed on the target moving image. The service identifier is, for example, “viewing” or “purchase”.

(S804) The reward means 1365 acquires a reward amount using one or multiple pieces of information among the attribute value set acquired in S802 and the service identifier acquired in S803.

In the case of multiple beneficiary identifiers being acquired, the reward means 1365 acquires a reward amount for each beneficiary identifier. In the case of beneficiary history information including multiple beneficiary identifiers being acquired, the reward means 1365 may acquire a reward amount for each beneficiary identifier.

It is preferable that the reward means 1365 determines, for example, a larger reward amount as the data amount, moving image time, or number of frames of the original moving image adopted in the moving image transmitted by the moving image output portion 143 increases. It is preferable that the reward means 1365 determines, for example, a larger reward amount as the resolution of the original moving image adopted in the moving image transmitted by the moving image output portion 143 increases.

(S805) The reward means 1365 performs processing to give a reward in the amount of the reward amount acquired in S804 to the beneficiary identified by the beneficiary identifier acquired in S801.

(S806) The reward means 1365 performs processing to make a user who enjoyed a service related to the target moving image bear the reward. The process returns to the upper level processing. It is noted that the target moving image is normally a moving image transmitted to the user terminal 3.

In the flowchart of FIG. 8, profit obtained by the operating side of the information processing device 1 may be acquired and accumulated.

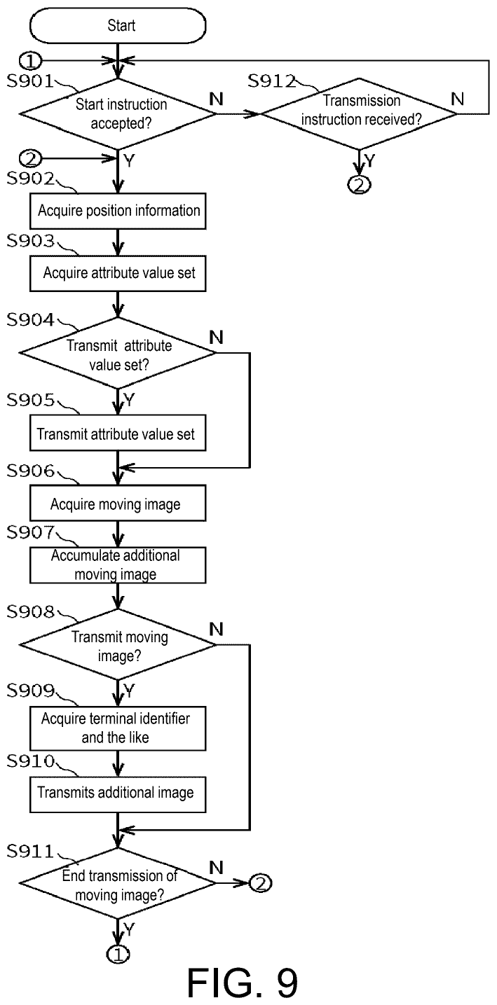

Next, an operation example of the mobile terminal 2 is described using the flowchart of FIG. 9.

(S901) The mobile terminal 2 determines whether or not a start instruction has been accepted. In the case of accepting a start instruction, the process goes to S902, and in the case of not accepting, the process goes to S912. It is noted that the start instruction is, for example, a startup instruction for a moving image transmission application or power ON of the mobile terminal 2.

(S902) The position acquisition portion 231 acquires the position information.

(S903) The attribute value acquisition portion 233 acquires one or more attribute values excluding the position information. It is noted that the attribute values include, for example, time information and road attribute values. The attribute value acquisition portion 233 configures an attribute value set including multiple attribute values including the acquired position information.

(S904) The mobile processing portion 23 determines whether or not to transmit the attribute value set to the information processing device 1. In the case of transmitting the attribute value set, the process goes to S905, and in the case of not transmitting, the process goes to S906. The case of transmitting the attribute value set is, for example, in the case of the attribute value set flag being “ON”. Further, for example, the initial value of the attribute value set flag is “ON”. It is noted that the method for determining whether or not to transmit the attribute value set to the information processing device 1 does not matter.

(S905) The mobile transmission portion 24 acquires a terminal identifier from the mobile storage portion 21. The mobile transmission portion 24 transmits the attribute value set to the information processing device 1 in association with the terminal identifier.

(S906) The shooting portion 232 performs shooting and acquires a moving image.

(S907) The configuration portion 234 configures an additional moving image having a moving image, position information, and one or more attribute values. The configuration portion 234 accumulates the additional moving image in the mobile storage portion 21.

(S908) The mobile moving image transmission portion 242 determines whether or not to transmit the moving image to the information processing device 1. In the case of transmitting the moving image, the process goes to S909, and in the case of not transmitting, the process goes to S911. It is noted that when transmitting a moving image, for example, the moving image transmission flag may be “ON”. Further, the initial value of the moving image transmission flag is, for example, “OFF”. Further, the method for determining whether or not to transmit the moving image to the information processing device 1 does not matter.

(S909) The configuration portion 234 acquires a terminal identifier and the like from the mobile storage portion 21.

(S910) The mobile moving image transmission portion 242 transmits the additional image accumulated in S907 to the information processing device 1 in association with the terminal identifier acquired in S909. It is noted that the amount of moving image transmitted at one time does not matter.

(S911) The mobile processing portion 23 determines whether or not to end transmission of the moving image. In the case of ending the transmission, the process returns to S901, and in the case of not ending the transmission, the process returns to S902. It is noted that the case of ending the transmission is, for example, when an end instruction from a user is accepted.

(S912) The mobile acceptance portion 22 determines whether or not a transmission instruction has been received from the information processing device 1. In the case of receiving the transmission instruction, the process goes to S902, and in the case of not receiving the transmission instruction, the process returns to S901. It is noted that in the case of receiving the transmission instruction, it is determined to “transmit the moving image” in S908. In the case of receiving the transmission instruction, it is preferable that it is determined to “not transmit the attribute value set” in S904.

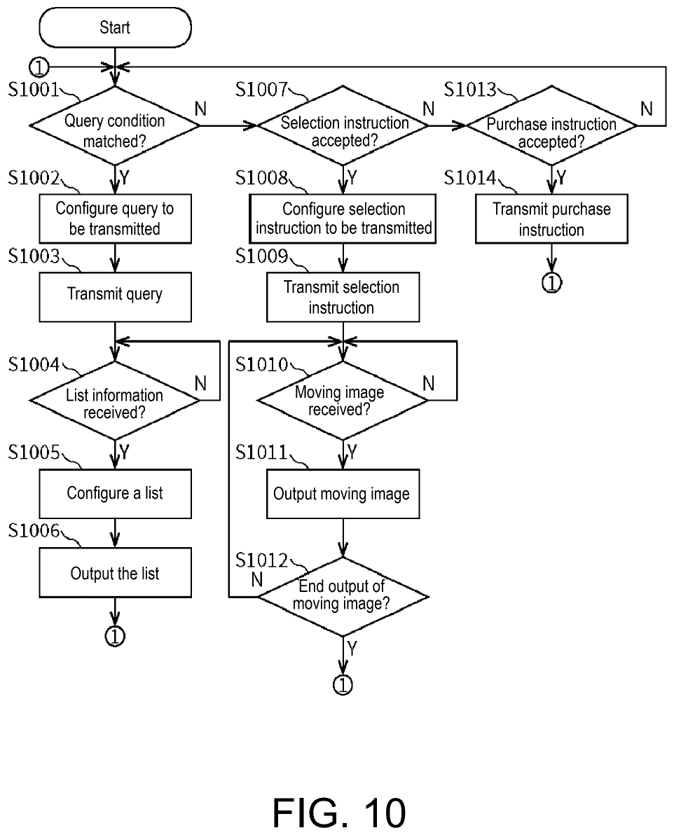

Next, an operation example of the user terminal 3 is described using the flowchart of FIG. 10.

(S1001) The user processing portion 33 determines whether or not a query condition has been matched. In the case of matching the query condition, the process goes to S1002, and in the case of not matching the query condition, the process goes to S1007.

(S1002) The user processing portion 33 configures a query corresponding to the query condition. The user processing portion 33 configures, for example, a query associated with a user identifier. The user processing portion 33 acquires, for example, a current position and configures a query having departure point information corresponding to the current position. The departure point information may be the position information indicating the current position or may be the location information.

(S1003) The user transmission portion 34 transmits the query configured in S1002 to the information processing device 1.

(S1004) The user reception portion 35 determines whether or not the list information has been received from the information processing device 1. In the case of receiving the list information, the process goes to S1005, and in the case of not receiving the list information, the process returns to S1004.

(S1005) The user processing portion 33 configures a list using the received list information.

(S1006) The user output portion 36 outputs the list configured in S1005. The process returns to S1001.

(S1007) The user acceptance portion 32 determines whether or not a selection instruction for one selection object in the output list has been accepted. In the case of accepting the selection instruction, the process goes to S1008, and in the case of not accepting the selection instruction, the process goes to S1013.

(S1008) The user processing portion 33 configures a selection instruction to be transmitted. The user processing portion 33 configures, for example, a selection instruction having a terminal identifier corresponding to the selected selection object. The user processing portion 33 configures, for example, a selection instruction having a moving image identifier corresponding to the selected selection object.

(S1009) The user transmission portion 34 transmits the selection instruction configured in S1008 to the information processing device 1.

(S1010) The user reception portion 35 determines whether or not a moving image has been received from the information processing device 1. In the case of receiving the moving image, the process goes to S1011, and in the case of not receiving the moving image, the process returns to S1010. It is noted that the moving image is normally an additional moving image.

(S1011) The user output portion 36 outputs the moving image received in S1010. The user processing portion 33 may accumulate the moving image received in S1010 in the user storage portion 31.

(S1012) The user processing portion 33 determines whether or not to end the output of the moving image. In the case of ending the output of the moving image, the process returns to S1001, and in the case of not ending the output of the moving image, the process returns to S1010. It is noted that, for example, in the case of accepting an instruction to end the moving image output from the user, the user processing portion 33 determines to end the output of the moving image.

(S1013) The user acceptance portion 32 determines whether or not a purchase instruction has been accepted from the user. In the case of accepting the purchase instruction, the process goes to S1014, and in the case of not accepting the purchase instruction, the process returns to S1001. It is noted that the purchase instruction includes, for example, a query.

(S1014) The user processing portion 33 configures a purchase instruction to be transmitted. Next, the user transmission portion 34 transmits the purchase instruction to the information processing device 1 in association with the user identifier. The process returns to S1001.

It is noted that in the flowchart of FIG. 10, the user terminal 3 may accept a browsing instruction, receive a moving image corresponding to the browsing instruction, and output the moving image.

Furthermore, in the flowchart of FIG. 10, the processing ends due to interruption by power-off or processing termination.

### <Specific Example>

Hereinafter, a specific operation example of the information system A in this embodiment will be described. In this specific example, the mobile terminal 2 is, for example, a terminal having a function of a drive recorder, or a smartphone equipped with a camera. The user terminal 3 is a navigation terminal installed in a mobile object, or a smartphone held by a user.

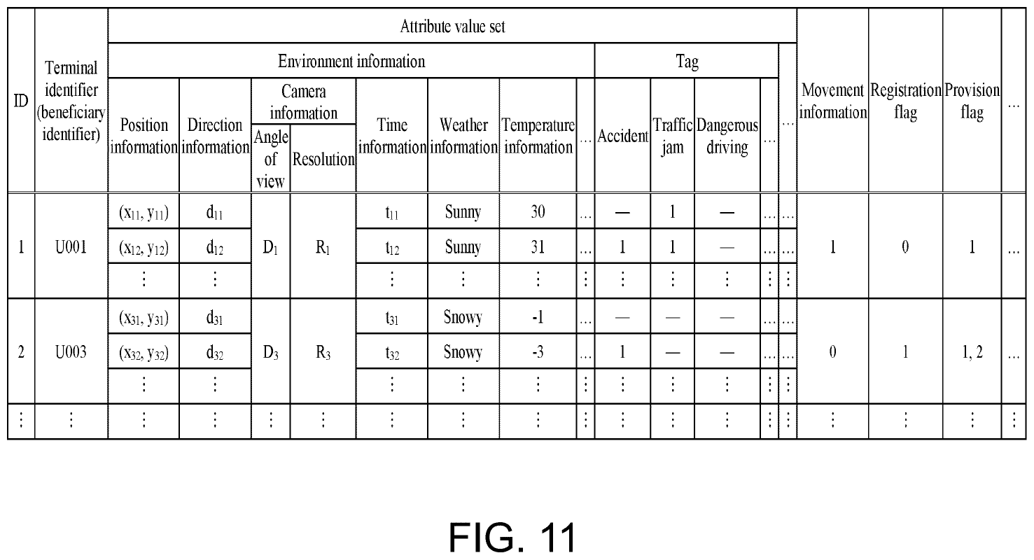

The terminal management portion 111 of the information processing device 1 stores a terminal management table shown in FIG. 11. The terminal management table is a table that manages terminal information of one or multiple mobile terminals 2.

The terminal management table manages one or more records having “ID,” “terminal identifier,” “attribute value set,” “movement information,” “registration flag,” and “provision flag”. The “attribute value set” has “environment information” and “tag”. The “environment information” has “position information,” “direction information,” “camera information,” “time information,” “weather information,” and “temperature information”. The “camera information” has “angle of view” and “resolution”. The “environment information” is information about the environment around the mobile terminal 2 according to the case of the image being acquired, etc. The “tag” has “accident,” “traffic jam,” and “dangerous driving”. That is, here, one or more tags among, for example, “accident,” “traffic jam,” and “dangerous driving” may be assigned to fields constituting the moving image transmitted from the mobile terminal 2. The “attribute value set” in the terminal management table is an attribute value set that one or more mobile terminals 2 each transmit continuously (e.g., periodically). It is noted that all or part of the one or more mobile terminals 2 may continuously transmit moving images in addition to the attribute value set.

“ID” is information that identifies a record. “Terminal identifier” is an identifier of the mobile terminal 2, and is the same as a beneficiary identifier that identifies a beneficiary of an image according to the case of image transmission. “Position information” is (latitude, longitude) here. “Direction information” is a shooting direction of a camera, and here is a clockwise angle from true north. That is, according to the case of the shooting direction of the camera being due east, the direction information is “90 degrees”. “Angle of view” is an angle of view of the camera. “Resolution” is a resolution of the camera. “Time information” is year, month, day, hour, minute, and second here. “Weather information” is, for example, “sunny,” “rainy,” “cloudy,” and “snowy”. “Temperature information” is an air temperature (° C.) outside the mobile object. A value “1” of “accident” indicates that an accident has occurred. A value “1” of “traffic jam” indicates that a traffic jam is occurring. A value “1” of “dangerous driving” indicates that an automobile or the like traveling ahead is driving dangerously. “Movement information=1” indicates that the mobile terminal 2 is currently in a state capable of transmitting images. “Movement information=0” indicates that the mobile terminal 2 is currently in a state incapable of transmitting images due to power OFF or the like. “Registration flag=1” indicates that an image is already registered and the image may be acquired from a registration destination (e.g., the storage portion 11 or another device). “1” of “provision flag” indicates that viewing of an image is permitted. “2” of “provision flag” indicates that sale of an image (transfer of a beneficiary) is permitted. It is noted that “attribute value set,” “movement information,” “registration flag,” and “provision flag” are information transmitted from the mobile terminal 2 and accumulated in the information processing device 1.

Further, a query management table shown in FIG. 12 is stored in the user storage portion 31 of each of one or multiple user terminals 3. The query management table is a table that manages query information. The query management table has “ID,” “query condition,” and “source information”. “ID” is information that identifies a record. “Source information” is information that becomes a source of a configured query.

The record of “ID=1” in FIG. 12 means that in response to the power of the user terminal 3 being turned ON or in response to a map being output, area information that specifies an area of the output map is acquired, and a query “query (area information)” having the area information is configured. It is noted that the area information is, for example, the upper left coordinates (x1, y1) and lower right coordinates (x2, y2) of a rectangular area. The coordinates are, for example, (latitude, longitude).

The record of “ID=2” in FIG. 12 means that in response to a destination being input in the user terminal 3, a query “query (one or more pieces of specific information)” having specific information that specifies each of one or multiple routes from a current position to the destination is configured.

The record of “ID=3” in FIG. 12 means that in the case of the user terminal 3 detecting congestion, a query “query (route information from a current position)” having route information from a current position to a destination is configured.

The record of “ID=4” in FIG. 12 means that in the case of arriving at a destination, a query “query (surrounding POI)” including location information of POI around the destination is configured.

In such a situation, the following four specific examples are described. Each of the four specific examples corresponds to each record of the query management table (FIG. 12).

### Specific Example 1

It is assumed that the user turned ON the engine of the automobile. Then, it is assumed that the power of the user terminal 3, which is a navigation terminal of the automobile, is turned ON, and a map is output on the display of the user terminal 3. Next, the user processing portion 33 acquires a current position and acquires map information of a surrounding area of the current position from the user storage portion 31. The user output portion 36 outputs a map using the map information. Next, the user processing portion 33 determines that it matches the query condition of “ID=1” in the query management table (FIG. 12). Next, the user processing portion 33 acquires area information (x₁,y₁)(x2,y2) and configures a query “query ((x₁,y₁)(x2,y2))” including the area information. Next, the user transmission portion 34 transmits the query to the information processing device 1.

Next, the inquiry acceptance portion 122 of the information processing device 1 receives “query ((x₁,y₁)(x2,y2))” from the user terminal 3.

Next, the list acquisition portion 134 refers to the terminal management table (FIG. 11), determines one or more pieces of position information existing within an area specified by area information (x₁,y₁)(x2,y2) among position information included in each terminal information, and acquires terminal identifiers paired with each of the one or more pieces of position information. Then, the list acquisition portion 134 configures a selection object for each of the one or more terminal identifiers according to the operation of the flowchart in FIG. 5. The selection object here has a location name corresponding to the position information included in the terminal information and a terminal identifier. Further, it is assumed that the list acquisition portion 134 configures four selection objects here. Next, the list acquisition portion 134 acquires list information having four selection objects. Next, the list output portion 142 transmits the list information to the user terminal 3.

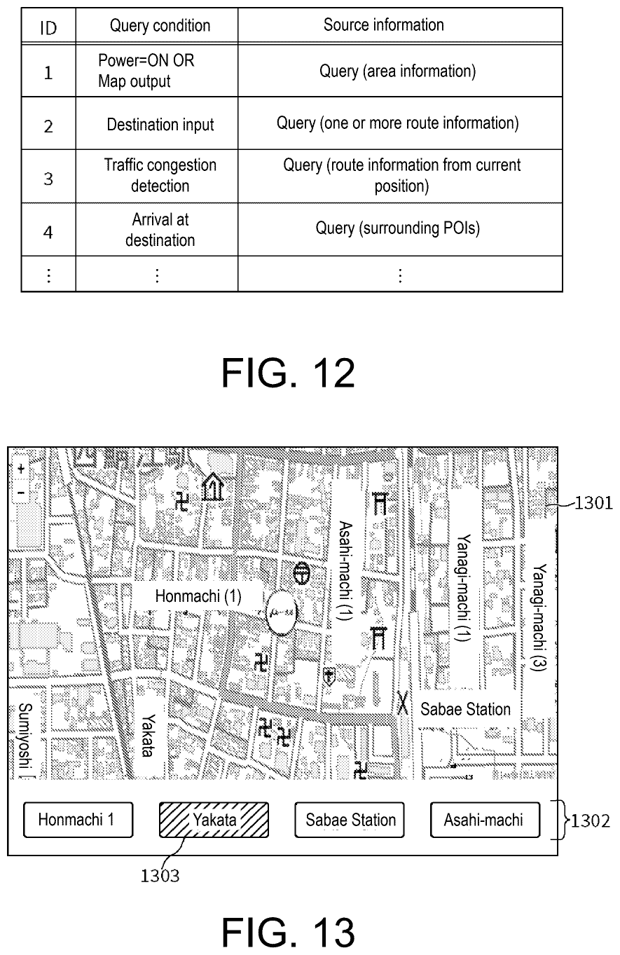

Next, the user terminal 3 receives the list information and outputs a list based on the list information. By outputting such a list, the screen of the user terminal 3 becomes FIG. 13. In FIG. 13, 1301 is the output map. 1302 is the output list. List 1302 has four selectable selection objects. The selection objects here include location names corresponding to the position information of the mobile terminal 2.

Next, it is assumed that the user instructed selection object “Ogata” 1303 on the screen of FIG. 13.

Next, the user terminal 3 accepts a selection instruction for the selection object “Ogata” 1303. Next, the user processing portion 33 configures a selection instruction to transmit. Here, it is assumed that the selection instruction has the terminal identifier “U001” paired with the selection object “Ogata” 1303. Next, the user transmission portion 34 transmits the configured selection instruction “<terminal identifier>U001” to the information processing device 1.

Next, the selection acceptance portion 123 of the information processing device 1 receives the selection instruction from the user terminal 3. Next, the moving image acquisition portion 135 acquires a moving image corresponding to the terminal identifier “U001” included in the received selection instruction according to the operation of the flowchart in FIG. 6. Next, the moving image output portion 143 transmits the acquired moving image to the user terminal 3.

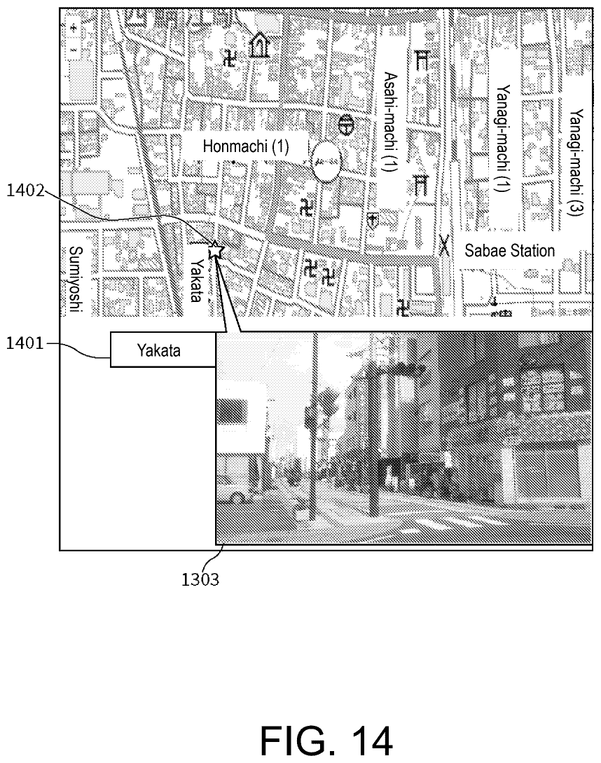

Next, the user terminal 3 receives and outputs the moving image. Here, the user terminal 3 stops outputting the list and outputs the received moving image. Such an output example is FIG. 14. In FIG. 14, a location name 1401 corresponding to the selected selection object, a symbol 1402 indicating the location of the mobile terminal 2 on the map, and a moving image 1403 are output. Further, in FIG. 14, the moving image 1403 is associated with a position on a map specified by the position information corresponding to the moving image 1403.

As described above, according to Specific Example 1, the user may view in advance a moving image of a location the user is about to pass through.

### Specific Example 2

Next, it is assumed that the user input “destination X” to the navigation software of the user terminal 3. Next, the user acceptance portion 32 of the user terminal 3 accepts “destination X”. Next, the user processing portion 33 determines that it matches the query condition of “ID=2” in the query management table (FIG. 12). Next, the user processing portion 33 performs route search from the current position to the destination X and acquires three pieces of route information. It is assumed that the routes specified by the three pieces of route information are route 1, route 2, and route 3. Next, the user processing portion 33 configures “query (route information of route 1, route information of route 2, route information of route 3)” using the source information of “ID=2”. Next, the user transmission portion 34 transmits the query to the information processing device 1.

Next, the inquiry acceptance portion 122 of the information processing device 1 receives “query (route information of route 1, route information of route 2, route information of route 3)” from the user terminal 3.

Next, the list acquisition portion 134 refers to the terminal management table (FIG. 11) and determines one or more terminal identifiers corresponding to the position information on the routes specified by each of the three pieces of route information. Then, the list acquisition portion 134 acquires the list information according to the operation of the flowchart in FIG. 5. Next, the list output portion 142 transmits the list information to the user terminal 3. Here, each selection object constituting the list information has a moving image or a thumbnail image of the moving image, congestion level on the route, and route name. Since the method for acquiring the congestion level is a known technique, detailed description is omitted.

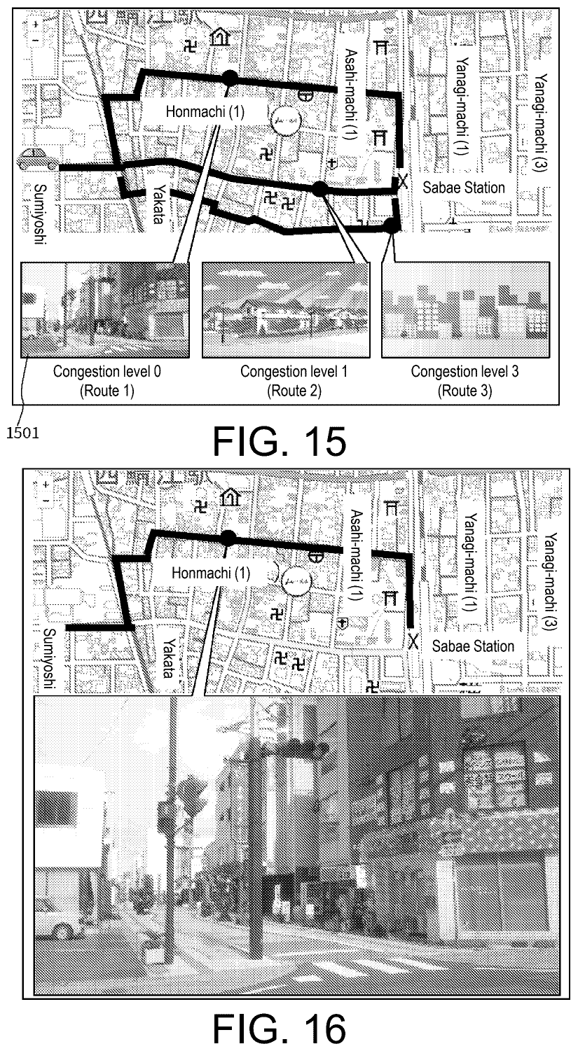

Next, the user terminal 3 receives the list information and outputs a list based on the list information. An example of such output of the list information is FIG. 15. In FIG. 15, the selection objects constituting the list include moving images or thumbnail images of moving images.

Next, it is assumed that the user instructed the selection object 1501 on the screen of FIG. 15.

Next, the user terminal 3 accepts a selection instruction for the selection object 1501. Next, the user processing portion 33 sets the route to route 1. Next, the user processing portion 33 configures a selection instruction to transmit. Here, it is assumed that the selection instruction has the terminal identifier “U001” that is paired with the selection object 1501. Next, the user transmission portion 34 transmits the configured selection instruction to the information processing device 1.

Next, the selection acceptance portion 123 of the information processing device 1 receives the selection instruction from the user terminal 3. Next, the moving image acquisition portion 135 acquires a moving image corresponding to the received selection instruction according to the operation of the flowchart in FIG. 6. Next, the moving image output portion 143 transmits the acquired moving image to the user terminal 3.

Next, the user terminal 3 receives and outputs the moving image. Here, the user terminal 3 stops outputting the list information and outputs the received moving image. Such an output example is FIG. 16.

As described above, according to Specific Example 2, the user may select a route while viewing moving images of multiple candidate routes, and may sufficiently understand the situation of the selected route through the moving image.

### Specific Example 3

After that, it is assumed that the automobile equipped with the user terminal 3 encountered traffic congestion. Then, it is assumed that the user processing portion 33 of the user terminal 3 detected traffic congestion. Next, the user processing portion 33 determines that it matches the query condition of “ID=3” in the query management table (FIG. 12). Next, the user processing portion 33 acquires route information from the current position to destination X. The route information here is information of the route of route 1 selected by the user. Next, the user processing portion 33 configures “query (route information of route 1)” using the original information of “ID=3”. Next, the user transmission portion 34 transmits the query to the information processing device 1. It is noted that the route information of route 1 has the position information of multiple locations that specify the route from the current position of the user terminal 3 to the destination X.

Next, the inquiry acceptance portion 122 of the information processing device 1 receives “query (route information of route 1)” from the user terminal 3.

Next, the list acquisition portion 134 refers to the terminal management table (FIG. 11) and determines one or more terminal identifiers corresponding to the position information on the route specified by the route information. Then, the list acquisition portion 134 acquires the list information according to the operation of the flowchart in FIG. 5. Next, the list output portion 142 transmits the list information to the user terminal 3. It is noted that here, each selection object constituting the list information has a location name and congestion level.

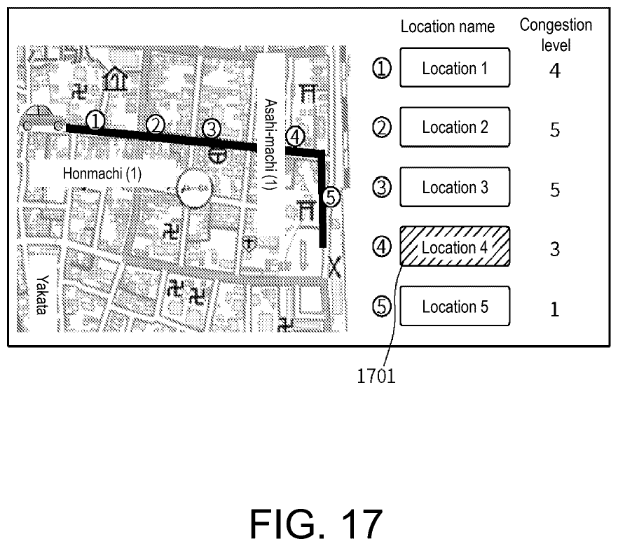

Next, the user terminal 3 receives the list information and outputs the list. An example of such list output is FIG. 17. In FIG. 17, a location name and congestion level are output for each selection object.

Next, it is assumed that the user instructed the selection object of location 4 on the screen of FIG. 17. The selection object of location 4 is a selection object 1701.

Next, the user terminal 3 accepts a selection instruction for the selection object 1701. Next, the user processing portion 33 configures a selection instruction to transmit. Here, it is assumed that the selection instruction has the terminal identifier “U001” that is paired with the selection object 1701. Next, the user transmission portion 34 transmits the configured selection instruction to the information processing device 1.

Next, the selection acceptance portion 123 of the information processing device 1 receives the selection instruction from the user terminal 3. Next, the moving image acquisition portion 135 acquires a moving image corresponding to the received selection instruction according to the operation of the flowchart in FIG. 6. Next, the moving image output portion 143 transmits the acquired moving image to the user terminal 3.

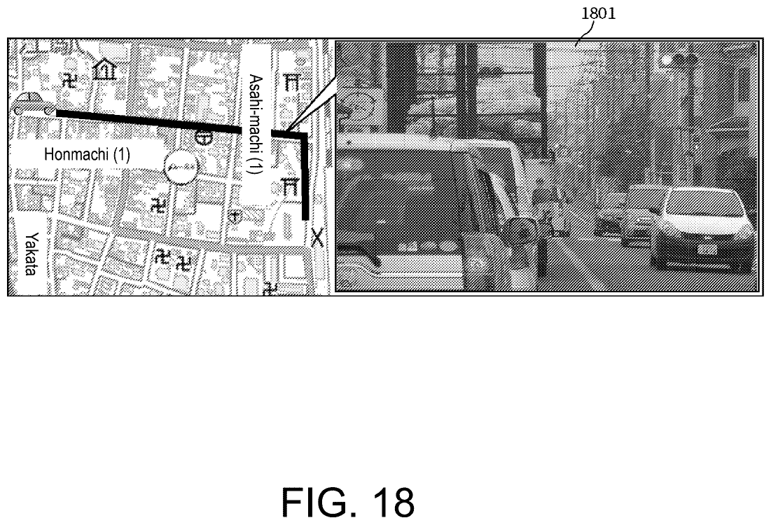

Next, the user terminal 3 receives and outputs the moving image. Here, the user terminal 3 stops outputting the list information and outputs the received moving image. Such an output example is FIG. 18. In FIG. 18, the moving image 1801 is output in association with location 4 corresponding to the selected selection object.

As described above, according to Specific Example 3, triggered by the user terminal 3 detecting congestion, a list of moving images that the user may select is presented. As a result, the user may easily obtain necessary moving images.

### Specific Example 4

Next, it is assumed that the user terminal 3 has arrived at the destination X. Then, it is assumed that the user processing portion 33 of the user terminal 3 detected that the user has arrived at the location of the destination X that was set. Next, the user processing portion 33 determines that it matches the query condition of “ID=4” in the query management table (FIG. 12). Next, the user processing portion 33 acquires the source information of “ID=4” in the query management table (FIG. 12). Next, the user processing portion 33 acquires the current position based on the source information and acquires one or more location information indicating POIs around the current position. Here, it is assumed that the user processing portion 33 acquired four location information (location A, location B, location C, location D). Next, the user processing portion 33 configures “query (location A, location B, location C, location D)”. Next, the user transmission portion 34 transmits the query to the information processing device 1.

Next, the inquiry acceptance portion 122 of information processing device 1 receives “query (location A, location B, location C, location D)” from the user terminal 3.

Next, the list acquisition portion 134 refers to the terminal management table (FIG. 11) and determines one or more terminal identifiers corresponding to the position information specified by each of the four location information. Then, the list acquisition portion 134 acquires the list information according to the operation of the flowchart in FIG. 5. Next, the list output portion 142 transmits the list information to the user terminal 3. Here, each selection object configuring the list information has a location name.

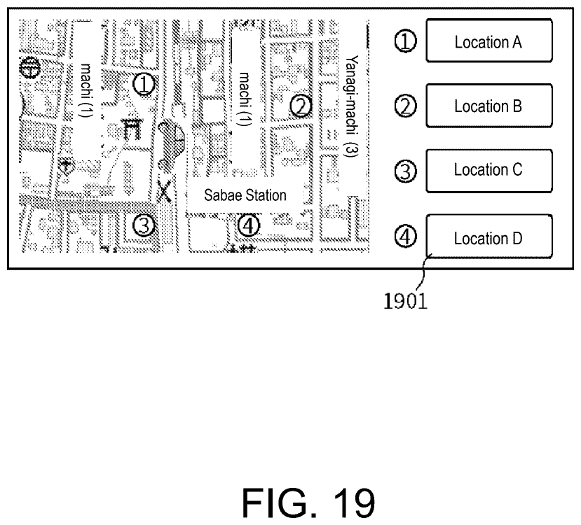

Next, the user terminal 3 receives the list information and outputs the list. An example of such list output is FIG. 19. In FIG. 19, positions of locations corresponding to each of the four selection objects are shown on the map.

Next, it is assumed that the user instructed the selection object 1901 on the screen of FIG. 19.

Next, the user terminal 3 accepts a selection instruction for the selection object 1901. Next, the user processing portion 33 configures a selection instruction to transmit. Here, it is assumed that the selection instruction has the terminal identifier “U001” that is paired with the selection object 1901. Next, the user transmission portion 34 transmits the configured selection instruction to the information processing device 1.

Next, the selection acceptance portion 123 of the information processing device 1 receives the selection instruction from the user terminal 3. Next, the moving image acquisition portion 135 acquires a moving image corresponding to the received selection instruction according to the operation of the flowchart in FIG. 6. Next, the moving image output portion 143 transmits the acquired moving image to the user terminal 3.

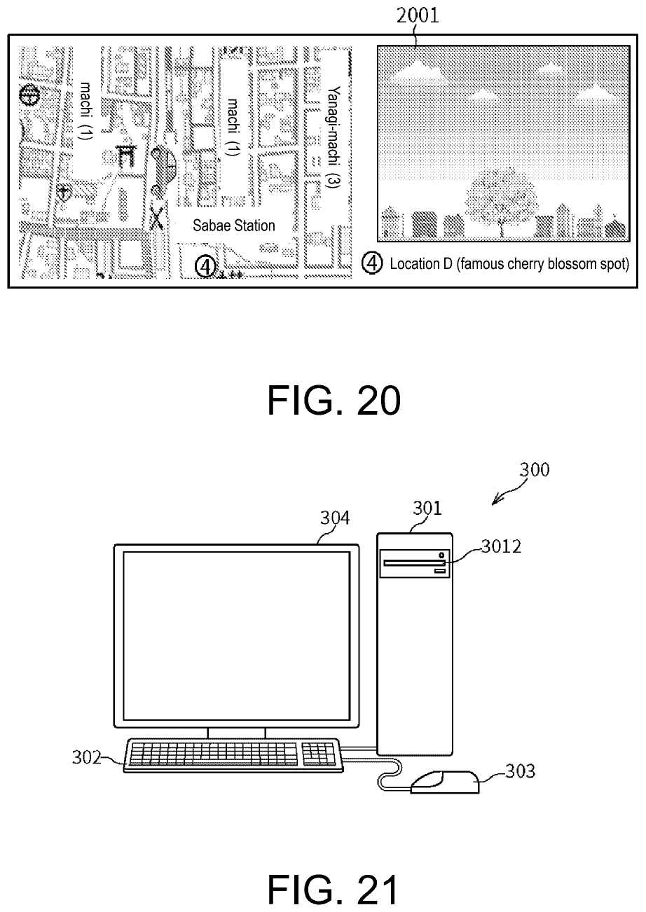

Next, the user terminal 3 receives and outputs the moving image. Such an output example is FIG. 20. In FIG. 20, the location name (location D) corresponding to the selected selection object, attribute value “famous cherry blossom spot” of the location, and moving image 2001 are output. Here, it is assumed that the attribute value “famous cherry blossom spot” is, for example, information that the user processing portion 33 acquired from the map information.

As described above, according to Specific Example 4, the user may obtain a list for selecting moving images of surrounding POIs triggered by arrival at the destination. As a result, the user may easily obtain necessary moving images after arriving at the destination.

As described above, according to this embodiment, moving images desired by users may be provided from moving images transmitted by multiple mobile terminals.

Further, according to this embodiment, as a result of being able to output a list for moving image selection and map information, it becomes easier for users to select necessary moving images.

Further, according to this embodiment, since appropriate multiple mobile terminals 2 are selected, an appropriate list for moving image selection may be output.

Further, according to this embodiment, a list that makes it easy to select moving images may be output.

Further, according to this embodiment, moving images shot previously may also be output.

Further, according to this embodiment, appropriate processing regarding beneficiaries of moving images may be performed.

Further, according to this embodiment, rewards may be given to beneficiaries of moving images shot by the mobile terminals.

Furthermore, according to this embodiment, rewards may also be given to those who contributed to the configuration of list information.

It is noted that the processing in this embodiment may be implemented by software. Then, this software may be distributed by software download or the like. Further, this software may be recorded on a recording medium such as a CD-ROM and distributed. It is noted that this also applies to other embodiments in the present specification. It is noted that the software for realizing the information processing device 1 in this embodiment is a program as follows. That is, this program is a program that causes a computer to function as: a list acquisition portion that acquires list information including selection objects corresponding to each of a plurality of mobile terminals that match a selection condition, the selection objects being for selecting moving images transmitted by mobile terminals; a list output portion that outputs the list information; a selection acceptance portion that accepts an instruction for one selection object with respect to a list using the list information; a moving image acquisition portion that acquires a moving image associated with the one selection object for the instruction accepted by the selection acceptance portion; and a moving image output portion that outputs the moving image.

Further, the software for implementing the user terminal 3 in this embodiment causes a computer to function as: a user processing portion that determines whether or not a query condition for acquiring list information has been met; a user transmission portion that transmits a query to an information processing device when the user processing portion determines that the query condition has been met; a user reception portion that receives list information from the information processing device in response to transmission of the query; a user output portion that outputs a list based on the list information, the list being for selecting moving images; and a user acceptance portion that accepts a selection instruction for one selection object among selection objects included in the list, in which the user transmission portion transmits a selection instruction corresponding to the one selection object to the information processing device, the user reception portion receives a moving image from the information processing device in response to transmission of the selection instruction, and the user output portion outputs the moving image.

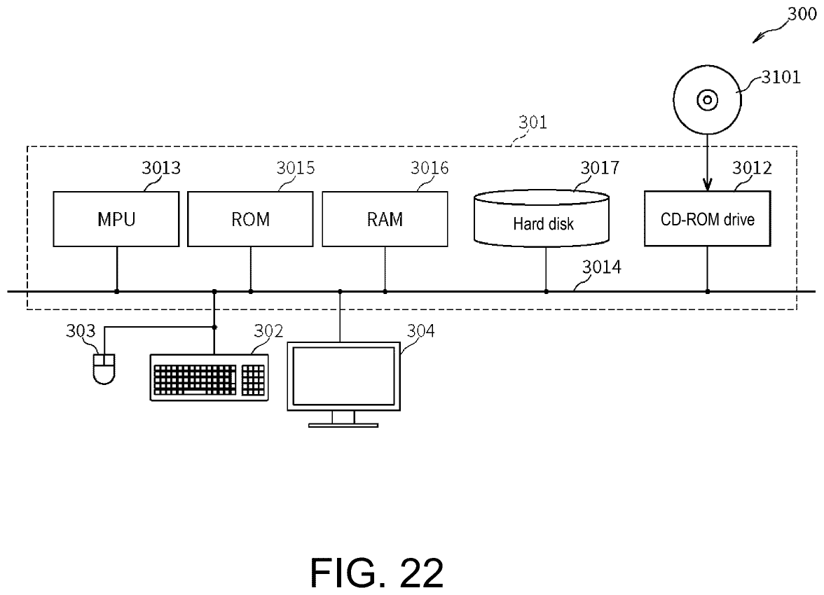

Further, FIG. 21 shows the external appearance of a computer that executes the programs described in the specification to implement the information processing device 1, the user terminal 3, etc., of the various embodiments described above. The above-described embodiments may be implemented by computer hardware and computer programs executed thereon. FIG. 21 is an overview diagram of this computer system 300, and FIG. 22 is a block diagram of the system 300.

In FIG. 21, the computer system 300 includes a computer 301 including a CD-ROM drive, a keyboard 302, a mouse 303, and a monitor 304.

In FIG. 22, the computer 301 includes, in addition to the CD-ROM drive 3012, an MPU 3013, a bus 3014 connected to the CD-ROM drive 3012 and the like, a ROM 3015 for storing programs such as boot-up programs, a RAM 3016 connected to the MPU 3013 for temporarily storing instructions of application programs and providing temporary storage space, and a hard disk 3017 for storing application programs, system programs, and data. Although not shown here, the computer 301 may further include a network card that provides connection to a LAN.

A program that causes the computer system 300 to execute the functions of the information processing device 1 and the like of the above-described embodiments may be stored in a CD-ROM 3101, inserted into the CD-ROM drive 3012, and further transferred to the hard disk 3017. Alternatively, the program may be transmitted to the computer 301 via a network not shown and stored in the hard disk 3017. The program is loaded into the RAM 3016 during execution. The program may be loaded directly from the CD-ROM 3101 or the network.

The program does not necessarily have to include an operating system (OS), third-party programs, or the like that cause the computer 301 to execute the functions of the information processing device 1 and the like of the above-described embodiments. The program only needs to include instruction portions that call appropriate functions (modules) in a controlled manner to obtain desired results. How the computer system 300 operates is well known, and detailed description is omitted.

It is noted that in the above program, steps of transmitting information, steps of receiving information, and the like do not include processing performed by hardware, for example, processing performed by modems, interface cards, and the like in transmission steps (processing that is performed only by hardware).

Further, the computer that executes the above program may be singular or multiple. That is, centralized processing may be performed, or distributed processing may be performed.

Further, in each of the above embodiments, it goes without saying that multiple communication means existing in one device may be physically implemented by one medium.

Further, in each of the above embodiments, each processing may be implemented by centralized processing by a single device, or may be implemented by distributed processing by multiple devices.

The disclosure is not limited to the above embodiments, and various modifications are possible, and it goes without saying that these are also included within the scope of the disclosure.

### INDUSTRIAL APPLICABILITY

As described above, the information processing device 1 according to the disclosure has an effect of being able to provide moving images desired by users from moving images transmitted by multiple mobile terminals, and is useful as a server or the like that provides moving images.

What is claimed is:

1. An information processing device comprising:
a list acquisition portion that acquires list information including selection objects corresponding to each of a plurality of mobile terminals that match a selection condition, the selection objects being for selecting images transmitted by mobile terminals;
a list output portion that outputs the list information;
a selection acceptance portion that accepts an instruction for one selection object with respect to a list using the list information;
an image acquisition portion that acquires an image associated with the one selection object for the instruction accepted by the selection acceptance portion; and
an image output portion that outputs the image,
wherein the image acquired by the image acquisition portion is associated with a beneficiary identifier that identifies a beneficiary of the image, the information processing device further comprises a beneficiary processing portion that performs a beneficiary processing, which is a processing related to a beneficiary identified by a beneficiary identifier associated with the image; and
a reward means that performs a reward processing, which is a processing for giving rewards to each beneficiary identified by the beneficiary identifier,
wherein the reward means also performs a reward processing for a beneficiary with respect to one or more of the selection objects that are mobile terminals corresponding to the selection objects and is associated with images other than the image acquired by the image acquisition portion.

2. The information processing device according to claim 1, wherein the list acquisition portion acquires list information including a plurality of selection objects including one or more road attribute values related to roads on which a mobile terminal moves.

3. The information processing device according to claim 2, wherein the one or more road attribute values include attribute values of roads through which the mobile terminal has passed or attribute values of a current position of the mobile terminal.

4. The information processing device according to claim 1, further comprising:
a map acquisition portion that acquires map information clearly indicating positions of each of the plurality of mobile terminals; and
a map output portion that outputs the map information when the list information is being output.

5. The information processing device according to claim 1, further comprising:
a determination portion that refers to a terminal management portion in which terminal information including one or more attribute values is stored in association with each of a plurality of mobile terminals, and determines a plurality of mobile terminals corresponding to one or more attribute values that match the selection condition,
wherein the list acquisition portion acquires list information including selection objects corresponding to each of the plurality of mobile terminals determined by the determination portion.

6. The information processing device according to claim 1, further comprising:
an inquiry acceptance portion that accepts a query having destination information,
wherein the selection condition is that location information included in destination information or route information corresponding to the mobile terminal satisfies a related condition with respect to the destination information accepted by the inquiry acceptance portion.

7. The information processing device according to claim 1, wherein the image acquisition portion acquires an image shot previously that is associated with the one selection object.

8. The information processing device according to claim 1, wherein the beneficiary processing portion comprises a third conservation means that accumulates an image output by the image output portion in association with a beneficiary identifier that identifies a user who requested the image.

9. A user terminal comprising:
a user processing portion that determines whether or not a query condition for acquiring list information has been met;
a user transmission portion that transmits a query to an information processing device when the user processing portion determines that the query condition has been met;
a user reception portion that receives list information from the information processing device in response to transmission of the query;
a user output portion that outputs a list based on the list information, the list being for selecting images; and
a user acceptance portion that accepts a selection instruction for one selection object among selection objects included in the list,
wherein the image is associated with a beneficiary identifier that identifies a beneficiary of the image, the information processing device further comprises a beneficiary processing portion that performs a beneficiary processing, which is a processing related to a beneficiary identified by a beneficiary identifier associated with the image; and
a reward means that performs a reward processing, which is a processing for giving rewards to each beneficiary identified by the beneficiary identifier,
wherein the user transmission portion transmits a selection instruction corresponding to the one selection object to the information processing device,
the user reception portion receives an image from the information processing device in response to transmission of the selection instruction,
the user output portion outputs the image,
the image is associated with a beneficiary identifier that identifies a beneficiary of the image, a beneficiary processing is performed, which is a processing related to a beneficiary identified by a beneficiary identifier associated with the image, a reward processing is performed, which is a processing for giving rewards to each beneficiary identified by the beneficiary identifier, and the reward means also performs a reward processing for a beneficiary with respect to one or more of the selection objects that are mobile terminals corresponding to the selection objects and is associated with images other than the image acquired by an image acquisition portion.

10. An information processing method implemented by a list acquisition portion, a list output portion, a selection acceptance portion, an image acquisition portion, an image output portion, a beneficiary processing portion, and a reward means, the information processing method comprising:
acquiring, by the list acquisition portion, list information including selection objects corresponding to each of a plurality of mobile terminals that match a selection condition, the selection objects being for selecting images transmitted by mobile terminals;
outputting, by the list output portion, the list information;
accepting, by the selection acceptance portion, an instruction for one selection object with respect to a list using the list information;
acquiring, by the image acquisition portion, an image associated with the one selection object for the instruction accepted by the selection acceptance portion;
outputting, by the image output portion, the image;
performing a beneficiary processing, which is a processing related to a beneficiary identified by a beneficiary identifier associated with the image; and
performing a reward processing, which is a processing giving rewards for a beneficiary with respect to one or more of the selection objects that are mobile terminals corresponding to each beneficiary identified by the beneficiary identifier and the selection objects and is associated with images other than the image acquired by the image acquisition portion.
